(19) United States
(12) Patent Application Publication
(10) Pub. No.: US 2009/0096816 A1
(43) Pub. Date: Apr. 16, 2009

(54) DATA DRIVER, INTEGRATED CIRCUIT DEVICE, AND ELECTRONIC INSTRUMENT

(75) Inventors: Haruo KAMIJO, Shiojiri-shi (JP); Katsuhiko MAKI, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/251,776

(22) Filed: Oct. 15, 2008

(30) Foreign Application Priority Data
Oct. 16, 2007 (JP) 2007-268835
May 23, 2008 (JP) 2008-135606

(51) Int. Cl. G09G 5/10

(52) U.S. Cl. 345/690

(57) ABSTRACT

A data driver includes a D/A conversion circuit that receives grayscale data and outputs a first grayscale voltage and a second grayscale voltage corresponding to the grayscale data by time division in each of first to Nth sampling periods, and first to Nth data line driver circuits that share the D/A conversion circuit. Each of the first to Nth data line driver circuits includes a grayscale generation amplifier that samples the first grayscale voltage and the second grayscale voltage output from the D/A conversion circuit in a corresponding sampling period among the first to Nth sampling periods, and generates a grayscale voltage between the first grayscale voltage and the second grayscale voltage.

Japanese Patent Application No. 2007-268835 filed on Oct. 16, 2007 and Japanese Patent Application No. 2008-135606 filed on May 23, 2008, are hereby incorporated by reference in their entirety.

### BACKGROUND

The present invention relates to a data driver, an integrated circuit device, an electronic instrument, and the like.

As a liquid crystal panel (electro-optical device or display panel) used for electronic instruments such as portable telephones, a simple matrix liquid crystal panel and an active matrix liquid crystal panel that utilizes a switch element such as a thin film transistor have been known.

In recent years, the number of data lines (source lines) of a liquid crystal panel has increased along with an increase in the screen size and the number of pixels. On the other hand, an increase in accuracy of a voltage applied to each data line has been desired. A reduction in power consumption and chip size of a data driver (source driver) that drives data lines of a liquid crystal panel has also been desired along with a demand for a reduction in weight and size of battery-driven electronic instruments provided with a liquid crystal panel.

For example, JP-A-2005-175811 and JP-A-2005-175812 disclose a configuration that enables a Rail-to-Rail operation of an output circuit of a data driver that drives a data line while supplying a voltage to the data line with high accuracy.

According to the technologies disclosed in JP-A-2005-175811 and JP-A-2005-175812, the Rail-to-Rail operation is implemented by controlling the drive capability by providing an auxiliary circuit in each output circuit. Therefore, the circuit scale of the data driver increases due to the addition of the auxiliary circuit. Moreover, the transistor size must be increased in order to suppress a variation in voltage applied to the data line.

In order to supply an accurate voltage to the data line, a voltage output from a D/A conversion circuit that generates a grayscale voltage corresponding to grayscale data must be supplied directly to the data line. Therefore, it is necessary to increase the number of grayscale voltage lines as the number of grayscales increases, whereby the chip size increases.

An operational amplifier must be normally designed taking a variation in output voltage into consideration. Therefore, it is necessary to suppress a variation in output voltage by increasing the size of a transistor that forms an operational amplifier.

### SUMMARY

According to one aspect of the invention, there is provided a data driver that drives a data line of an electro-optical device, the data driver comprising:

a D/A conversion circuit that receives grayscale data, and outputs a first grayscale voltage and a second grayscale voltage corresponding to the grayscale data by time division in each of first to Nth (N is an integer equal to or larger than two) sampling periods; and

first to Nth data line driver circuits that share the D/A conversion circuit,

each of the first to Nth data line driver circuits including a grayscale generation amplifier that samples the first grayscale voltage and the second grayscale voltage output from the D/A conversion circuit in a corresponding sampling period among the first to Nth sampling periods, and generates a grayscale voltage between the first grayscale voltage and the second grayscale voltage.

According to another aspect of the invention, there is provided an integrated circuit device comprising the above data driver.

According to another aspect of the invention, there is provided an electronic instrument comprising the above integrated circuit device.

### BRIEF DESCRIPTION OF THE DRAWINGS

FIG. 1 shows a configuration example of an integrated circuit device according to one embodiment of the invention.

FIG. 2 shows a configuration example of a data driver according to one embodiment of the invention.

FIG. 3 shows a second configuration example of a data driver.

FIG. 4 shows a signal waveform example illustrative of an operation according to one embodiment of the invention.

FIG. 5 is a view illustrative of a data line common potential setting method.

FIG. 6 shows a first modification of a data driver.

FIG. 7 is a view illustrative of the operations of a D/A conversion circuit, a switch circuit, and a grayscale generation amplifier.

FIGS. 8A and 8B are views illustrative of a flip-around sample-hold circuit.

FIGS. 9A and 9B show a configuration example of a grayscale generation amplifier using a flip-around sample-hold circuit.

FIG. 10 is a view illustrative of the circuit operation of a grayscale generation amplifier.

FIGS. 11A and 11B show a second configuration example of a grayscale generation amplifier.

FIG. 12 is a view illustrative of the circuit operation of a grayscale generation amplifier according to a second configuration example.

FIG. 13A to 13C are views illustrative of a switch control approach according to one embodiment of the invention.

FIG. 14 shows a configuration example of an operational amplifier of a grayscale generation amplifier.

FIG. 15 shows a second modification of a data driver.

FIG. 16 shows a detailed configuration example of a driver amplifier.

FIG. 17 shows a detailed configuration example of a driver amplifier.

FIG. 18 shows a configuration example of an operational amplifier of a driver amplifier.

FIG. 19 shows a third modification of a data driver.

FIG. 20 shows a configuration example of a D/A conversion circuit.

FIG. 21 shows a first configuration example of a first D/A converter and a second D/A converter.

FIG. 22 shows a second configuration example of a first D/A converter and a second D/A converter

FIG. 23 shows a modification of a D/A conversion circuit.

FIG. 24 is a view illustrative of a D/A conversion circuit according to a modification.

FIG. 25 shows a configuration example of a grayscale voltage generation circuit.

FIGS. 26A and 26B show configuration examples of an electronic instrument.

### DESCRIPTION OF EXEMPLARY EMBODIMENTS

Several aspects of the invention may provide a data driver, an integrated circuit device, and an electronic instrument that can supply a voltage to a data line by a small circuit configuration even when the number of grayscales increases. Further aspects of the invention may provide a data driver, an integrated circuit device, and an electronic instrument that can supply an accurate voltage that varies to only a small extent to a data line.

According to one embodiment of the invention, there is provided a data driver that drives a data line of an electro-optical device, the data driver comprising:

a D/A conversion circuit that receives grayscale data, and outputs a first grayscale voltage and a second grayscale voltage corresponding to the grayscale data by time division in each of first to Nth (N is an integer equal to or larger than two) sampling periods; and

first to Nth data line driver circuits that share the D/A conversion circuit,

each of the first to Nth data line driver circuits including a grayscale generation amplifier that samples the first grayscale voltage and the second grayscale voltage output from the D/A conversion circuit in a corresponding sampling period among the first to Nth sampling periods, and generates a grayscale voltage between the first grayscale voltage and the second grayscale voltage.

According to this embodiment, the D/A conversion circuit outputs the first grayscale voltage and the second grayscale voltage corresponding to the grayscale data by time division in each of the first to Nth sampling periods. The grayscale generation amplifier included in each of the first to Nth data line driver circuits samples the first grayscale voltage and the second grayscale voltage output from the D/A conversion circuit in a corresponding sampling period among the first to Nth sampling periods, and generates the grayscale voltage between the first grayscale voltage and the second grayscale voltage. According to this configuration, since it suffices to provide one D/A conversion circuit corresponding to the first to Nth data line driver circuits, the area of the D/A conversion circuit can be reduced. According to this embodiment, even if the D/A conversion circuit outputs the first grayscale voltage and the second grayscale voltage by time division, a voltage can be appropriately sampled in each of the first to Nth sampling periods by utilizing the sampling function of the grayscale generation amplifiers. Therefore, a data driver that can supply a voltage to the data line by a small circuit configuration even when the number of grayscales increases can be provided.

In the data driver,

the grayscale generation amplifier may be formed by a flip-around sample-hold circuit.

Since the grayscale generation amplifier can be provided with a voltage sample-hold function and an offset-free state can be implemented by utilizing the flip-around sample-hold circuit, a highly accurate voltage that varies to only a small extent can be supplied to the data line.

In the data driver,

the grayscale generation amplifier may include:

an operational amplifier;

a first sampling capacitor that is provided between a first input terminal of the operational amplifier and a first input node of the grayscale generation amplifier and stores a charge corresponding to an input voltage at the first input node in a sampling period; and

a second sampling capacitor that is provided between the first input terminal of the operational amplifier and a second input node of the grayscale generation amplifier and stores a charge corresponding to an input voltage at the second input node in the sampling period,

the grayscale generation amplifier may output an output voltage in a holding period, the output voltage corresponding to charges stored in the first sampling capacitor and the second sampling capacitor in the sampling period.

According to this configuration, the voltages input to the first input node and the second input node can be sampled into the first sampling capacitor and the second sampling capacitor in the sampling period, and the output voltage corresponding to charges stored in the first sampling capacitor and the second sampling capacitor can be output in the holding period by performing the flip-around operation of the first sampling capacitor and the second sampling capacitor.

In the data driver,

the grayscale generation amplifier may include:

an operational amplifier, a second input terminal of the operational amplifier being set at a given reference voltage;

a first sampling switch element and a first sampling capacitor, the first sampling switch element and the first sampling capacitor being provided between a first input node of the grayscale generation amplifier and a first input terminal of the operational amplifier;

a second sampling switch element and a second sampling capacitor, the second sampling switch element and the second sampling capacitor being provided between a second input node of the grayscale generation amplifier and the first input terminal of the operational amplifier;

a feedback switch element provided between an output terminal of the operational amplifier and the first input terminal of the operational amplifier;

a first flip-around switch element provided between a first connection node and the output terminal of the operational amplifier, the first connection node being situated between the first sampling switch element and the first sampling capacitor; and

a second flip-around switch element provided between a second connection node and the output terminal of the operational amplifier, the second connection node being situated between the second sampling switch element and the second sampling capacitor.

According to this configuration, the input voltages can be sampled into the first sampling capacitor and the second sampling capacitor using the first sampling switch element, the second sampling switch element, and the feedback switch element, and the flip-around operation of the first sampling capacitor and the second sampling capacitor can be implemented using the first flip-around switch element and the second flip-around switch element.

In the data driver,

the first sampling switch element, the second sampling switch element, and the feedback switch element may be turned ON and the first flip-around switch element and the second flip-around switch element may be turned OFF in the sampling period; and

the first sampling switch element, the second sampling switch element, and the feedback switch element may be turned OFF and the first flip-around switch element and the second flip-around switch element may be turned ON in a holding period.

Since the first sampling switch element, the second sampling switch element, and the feedback switch element are turned ON in the sampling period, charges corresponding to the input voltage can be stored in the first sampling capacitor and the second sampling capacitor utilizing the virtual short-circuit function of the operational amplifier. Since the first flip-around switch element and the second flip-around switch element are turned ON in the holding period, an output voltage corresponding to charges stored in the first sampling capacitor and the second sampling capacitor can be output to the output node of the grayscale generation amplifier.

In the data driver,

the grayscale generation amplifier may include an output switch element provided between the output terminal of the operational amplifier and an output node of the grayscale generation amplifier;

the output switch element may be turned OFF in the sampling period; and

the output switch element may be turned ON in a holding period.

Since the output switch element is turned OFF in the sampling period, a situation in which an indefinite voltage in the sampling period is transmitted to the subsequent stage can be prevented.

In the data driver,

the first sampling switch element and the second sampling switch element may be turned OFF after the feedback switch element has been turned OFF.

This minimizes an adverse effect of charge injection via the first sampling switch element, the second sampling switch element, and the like.

In the data driver,

the reference voltage set to the second input terminal of the operational amplifier may be an intermediate voltage between VDD and VSS,

switch control signals may be supplied to the first sampling switch element, the second sampling switch element, the feedback switch element, the first flip-around switch element, and the second flip-around switch element,

VDD may be a high-potential-side power supply voltage of the switch control signals, and VSS may be a low-potential-side power supply voltage of the switch control signals.

An adverse effect of charge injection can be further reduced by thus setting the reference voltage.

In the data driver,

each of the first to Nth data line driver circuits may include a driver amplifier provided in the subsequent stage of the grayscale generation amplifier.

Since the data line drive time can be increased by providing the driver amplifier the display quality can be improved.

In the data driver,

the driver amplifier may be formed by a flip-around sample-hold circuit.

Since the driver amplifier can be provided with a voltage sample-hold function and an offset-free state can be implemented by utilizing the flip-around sample-hold circuit, a highly accurate voltage that varies to only a small extent can be supplied to the data line.

In the data driver,

the driver amplifier may include:

a second operational amplifier; and

a sampling capacitor that is provided between a first input terminal of the second operational amplifier and an input node of the driver amplifier and stores a charge corresponding to an input voltage at the input node in a driver amplifier sampling period,

the driver amplifier may output an output voltage in a driver amplifier holding period, the output voltage corresponding to a charge stored in the sampling capacitor in the driver amplifier sampling period.

According to this configuration, the voltage input to the input node can be sampled into the sampling capacitor in the driver amplifier sampling period, and an output voltage corresponding to a charge stored in the sampling capacitor can be output in the driver amplifier holding period by performing the flip-around operation of the sampling capacitor.

In the data driver,

the driver amplifier may include:

a second operational amplifier, a second input terminal of the second operational amplifier being set at a given reference voltage;

a sampling switch element and a sampling capacitor, the sampling switch element and the sampling capacitor being provided between an input node of the driver amplifier and a first input terminal of the second operational amplifier;

a second feedback switch element provided between an output terminal of the second operational amplifier and the first input terminal of the second operational amplifier; and

a flip-around switch element provided between a connection node and the output terminal of the second operational amplifier, the connection node being situated between the sampling switch element and the sampling capacitor.

According to this configuration, the input voltage can be sampled into the sampling capacitor using the sampling switch element and the second feedback switch element, and the flip-around operation of the sampling capacitor can be implemented using the flip-around switch element.

In the data driver,

the operational amplifier included in the grayscale generation amplifier may be formed by an amplifier that performs a class A amplification operation; and

the second operational amplifier included in the driver amplifier may be formed by an amplifier that performs a class AB amplification operation.

This makes it possible to reduce power consumption while increasing the accuracy of the voltage supplied to the data line. Note that the operational amplifier of the driver amplifier may perform a class A amplification operation in the sampling period, and perform a class AB amplification operation in the holding period.

In the data driver,

the driver amplifier included in each of the first to Nth data line driver circuits may sample an output voltage from the grayscale generation amplifier in a driver amplifier sampling period after the first to Nth sampling periods, and may output the sampled output voltage in a driver amplifier holding period after the driver amplifier sampling period.

According to this configuration, even if the total time of the first to Nth sampling periods increases, the driver amplifiers are set in a holding operation mode in the first to Nth sampling periods so that the data lines can be driven. Therefore, the data line drive time can be increased so that a highly accurate voltage can be supplied to the data line.

In the data driver,

output lines of the driver amplifiers may be set at a common potential in the driver amplifier sampling period.

According to this configuration, since a charge can be recycled by setting the output lines of the driver amplifiers at the common potential effectively utilizing the driver amplifier sampling period, power consumption can be reduced.

In the data driver,

the D/A conversion circuit may output a maximum grayscale voltage as the first grayscale voltage and may output the maximum grayscale voltage as the second grayscale voltage when all bits of the grayscale data are set at a first logic level, and may output a minimum grayscale voltage as the first grayscale voltage and may output the minimum grayscale voltage as the second grayscale voltage when all bits of the grayscale data are set at a second logic level.

According to this configuration, since the maximum grayscale voltage and the minimum grayscale voltage can be adjusted independently of the grayscale intervals, convenience can be improved.

According to another embodiment of the invention, there is provided an integrated circuit device comprising one of the above data drivers.

According to another embodiment of the invention, there is provided an electronic instrument comprising the above integrated circuit device.

Preferred embodiments of the invention are described in detail below. Note that the following embodiments do not in any way limit the scope of the invention defined by the claims laid out herein. Note that all elements of the following embodiments should not necessarily be taken as essential requirements for the invention.

1. Integrated Circuit Device

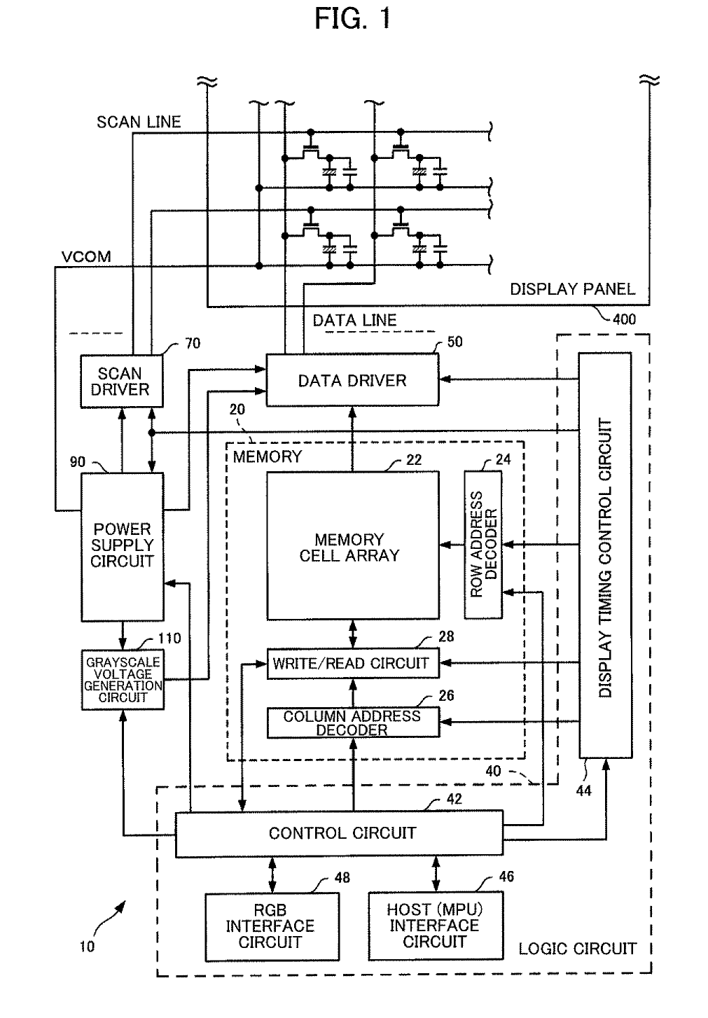

FIG. 1 shows a circuit configuration example of an integrated circuit device 10 (display driver) including a data driver according to one embodiment of the invention. Note that the integrated circuit device 10 according to this embodiment is not limited to the configuration shown in FIG. 1. Various modifications may be made such as omitting some of the elements or adding other elements.

A display panel 400 (electro-optical device in a broad sense) includes a plurality of data lines (source lines), a plurality of scan lines (gate lines), and a plurality of pixels specified by the data lines and the scan lines. A display operation is implemented by changing the optical properties of an electro-optical element (liquid crystal element in a narrow sense) in each pixel area. The display panel may be implemented by an active matrix panel using a switch element such as a TFT or a TFD, for example. Note that the display panel may be a panel other than the active matrix panel, or may be a panel (e.g., organic EL panel) other than the liquid crystal panel.

A memory 20 (display data RAM) stores image data. A memory cell array 22 includes a plurality of memory cells, and stores image data (display data) corresponding to at least one frame (one screen). A row address decoder 24 (MPU/LCD row address decoder) decodes a row address, and selects a wordline of the memory cell array 22. A column address decoder 26 (MPU column address decoder) decodes a column address, and selects a bitline of the memory cell array 22. A write/read circuit 28 (MPU write/read circuit) writes image data into the memory cell array 22, or reads image data from the memory cell array 22.

A logic circuit 40 (driver logic circuit) generates a control signal for controlling a display timing, a control signal for controlling a data processing timing, and the like. The logic circuit 40 may be formed by automatic placement and routing (e.g., gate array (G/A)), for example.

A control circuit 42 generates various control signals, and controls the entire device. Specifically, the control circuit 42 outputs grayscale adjustment data (gamma correction data) for adjusting grayscale characteristics (gamma characteristics) to a grayscale voltage generation circuit 110, or outputs power supply adjustment data for adjusting a power supply voltage to a power supply circuit 90. The control circuit 42 also controls a memory write/read process using the row address decoder 24, the column address decoder 26, and the write/read circuit 28.

A display timing control circuit 44 generates various control signals for controlling the display timing, and controls reading of image data from the memory 20 into the display panel. A host (MPU) interface circuit 46 implements a host interface that generates an internal pulse corresponding to each access from a host and accesses the memory 20. An RGB interface circuit 48 implements an ROB interface that writes motion picture RGB data into the memory 20 based on a dot clock signal. Note that the integrated circuit device 10 may be configured to include only one of the host interface circuit 46 and the RGB interface circuit 48.

A data driver 50 is a circuit that generates a data signal for driving the data line of the display panel. Specifically, the data driver 50 receives image data (grayscale data or display data) from the memory 20, and receives a plurality of (e.g., 256-stage) grayscale voltages (reference voltages) from the grayscale voltage generation circuit 110. The data driver 50 selects a voltage corresponding to the image data (grayscale data) from the plurality of grayscale voltages, and outputs the selected voltage to the data line of the display panel.

A scan driver 70 is a circuit that generates a scan signal for driving the scan line of the display panel. Specifically, the scan driver 70 sequentially shifts a signal (enable input-output signal) using a built-in shift register, and outputs a signal obtained by converting the level of the shifted signal to each scan line of the display panel as the scan signal (scan voltage). The scan driver 70 may include a scan address generation circuit and an address decoder. The scan address generation circuit may generate and output a scan address, and the address decoder may decode the scan address to generate the scan signal.

The power supply circuit 90 is a circuit that generates various power supply voltages. Specifically, the power supply circuit 90 increases an input power source voltage or an internal power supply voltage by a charge-pump method using a boost capacitor and a boost transistor included in a voltage booster circuit provided in the power supply circuit 90. The power supply circuit 90 supplies the resulting voltages to the data driver 50, the scan driver 70, the grayscale voltage generation circuit 110, and the like.

The grayscale voltage generation circuit 110 (gamma correction circuit) is a circuit that generates the grayscale voltage and supplies the grayscale voltage to the data driver 50. Specifically, the grayscale voltage generation circuit 110 may include a ladder resistor circuit that divides the voltage between a high-potential-side voltage and a low-potential-side voltage using resistors, and outputs the grayscale voltages to resistance division nodes. The grayscale voltage generation circuit 110 may also include a grayscale register section into which the grayscale adjustment data is written, a grayscale voltage setting circuit that variably sets (controls) the grayscale voltage output to the resistance division node based on the grayscale adjustment data written into the grayscale register section, and the like.

2. Data Driver

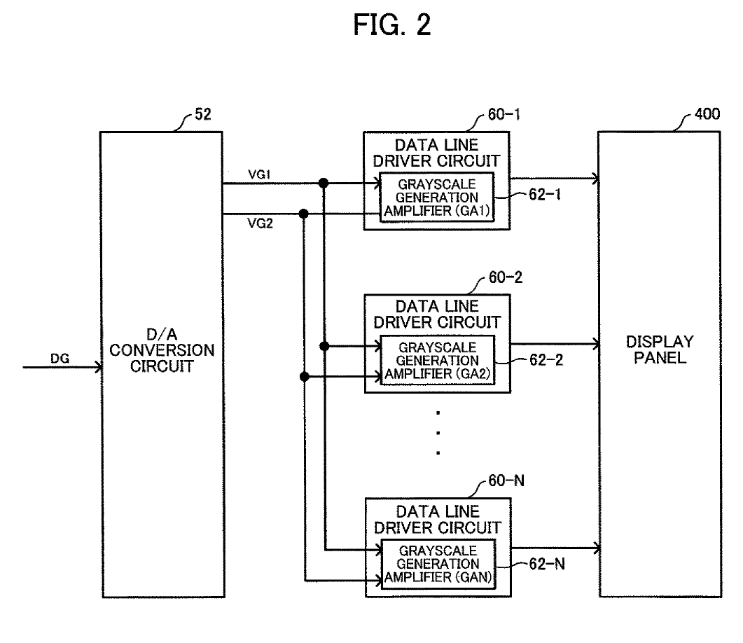

FIG. 2 shows a configuration example of the data driver (source driver) according to this embodiment. The data driver drives the data line of the display panel 400 (electro-optical device) such as a liquid crystal panel. The data driver includes a D/A conversion circuit 52 and data line driver circuits 60-1 to 60-N. In FIG. 2, the D/A conversion circuit 52 is shared by the data line driver circuits 60-1 to 60-N (first to Nth data line driver circuits). Note that the data line driver circuit and the like may be provided corresponding to each data line of the display panel, or the data line driver circuit drives a plurality of data lines by time division. Part or the entirety of the data driver (integrated circuit device) may be integrally formed on the display panel.

The D/A conversion circuit 52 (voltage generation circuit) receives grayscale data DG (image data or display data) from the memory 20 shown in FIG. 1, for example. The D/A conversion circuit 52 outputs a first grayscale voltage VG1 and a second grayscale voltage VG2 corresponding to the grayscale data DG.

Specifically, the D/A conversion circuit 52 receives the grayscale data, and outputs the first grayscale voltage VG1 and the second grayscale voltage VG2 corresponding to the grayscale data by time division in each of first to Nth sampling periods.

The data line driver circuits 60-1 to 60-N respectively include grayscale generation amplifiers 62-1 to 62-N (GA1 to GAN). The grayscale generation amplifiers 62-1 to 62-N sample the first grayscale voltage VG1 and the second grayscale voltage VG2 output from the D/A conversion circuit 52 in the first to Nth sampling periods, respectively, and generate a grayscale voltage between the first grayscale voltage VG1 and the second grayscale voltage VG2.

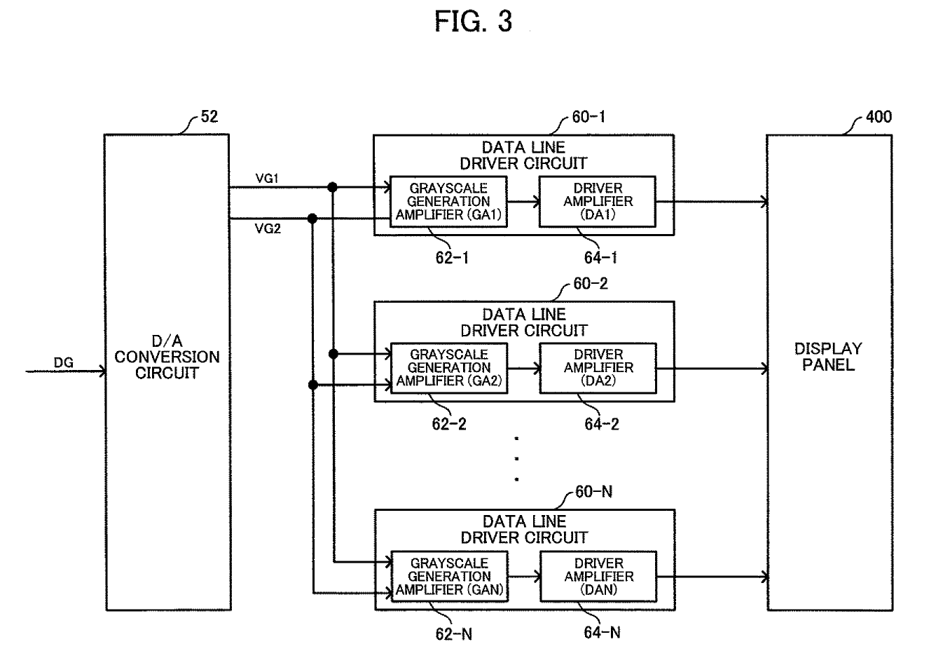

FIG. 3 shows a second configuration example of the data driver. In FIG. 3, the data line driver circuits 60-1 to 60-N respectively further include driver amplifiers 64-1 to 64-N provided in the subsequent stage of the grayscale generation amplifiers 62-1 to 62-N.

Note that a modification in which the driver amplifiers 64-1 to 64-N are omitted is also possible. The details of the D/A converter 52, the data line driver circuits 60-1 to 60-N, the grayscale generation amplifiers 62-1 to 62-N, and the driver amplifiers 64-1 to 64-N are described later

The driver amplifiers 64-1 to 64-N (DA1 to DAN) included in the data line driver circuits 60-1 to 60-N respectively sample the output voltages from the grayscale generation amplifiers 62-1 to 62-N in a driver amplifier sampling period after the first to Nth sampling periods. The driver amplifiers 64-1 to 64-N output the sampled output voltages in a driver amplifier holding period after the driver amplifier sampling period.

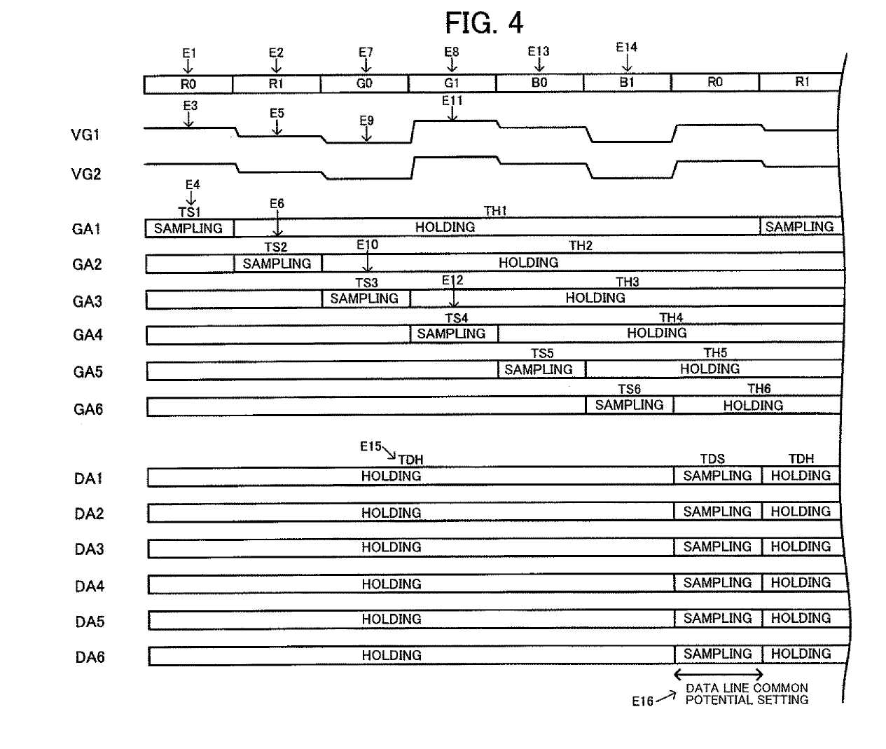

FIG. 4 shows a signal waveform example when the D/A conversion circuit 52 is shared by six data line driver circuits GA1 to GA6. The data line driver circuits GA1 to GA6 perform a sampling operation in sampling periods TS1 to TS6 (first to Nth sampling periods), and perform a holding operation in holding periods TH1 to TH6 (first to Nth holding periods) after the sampling periods TS1 to TS6, respectively.

The driver amplifiers DA1 to DA6 perform a sampling operation in a driver amplifier sampling period TDS after the sampling periods TS1 to TS6, and perform a holding operation in a driver amplifier holding period TDH after the driver amplifier sampling period TDS.

According to the configuration shown in FIGS. 2 and 3, it suffices to provide one D/A conversion circuit 52 corresponding to the data line driver circuits 60-1 to 60-N instead of providing the D/A conversion circuit corresponding to each data line driver circuit. Therefore, the area of the D/A conversion circuit 52 in the integrated circuit device can be reduced, whereby the size of the integrated circuit device can be reduced.

Even if the D/A conversion circuit 52 outputs the first grayscale voltage VG1 and the second grayscale voltage VG2 by time division, a voltage can be appropriately sampled in each of the first to Nth sampling periods by utilizing the sampling function of the grayscale generation amplifiers 62-1 to 62-N.

When using the D/A conversion circuit 52 by time division, the total time of the sampling periods TS1 to TS6 increases, as shown in FIG. 4. Therefore, the holding period TH6 of the grayscale generation amplifier GA6 decreases so that the data line drive time becomes insufficient, for example.

However, when the driver amplifiers DA1 to DA6 are provided in the subsequent stage of the grayscale generation amplifiers GA1 to GA6 (see FIG. 3), the driver amplifiers DA1 to DA6 are set in a holding operation mode in the sampling periods TS1 to TS6 (see E15 in FIG. 4) so that the data lines can be driven. Therefore, the data line drive time can be increased so that a highly accurate voltage can be supplied to the data line.

A data driver normally performs a DAC drive operation that directly drives the data line using a D/A conversion circuit in the latter half of a drive period in order to increase the accuracy of the voltage supplied to the data line. Therefore, since it is necessary to provide a D/A conversion circuit having an identical configuration corresponding to each data line, the size of the integrated circuit device increases due to an increase in the layout area of the D/A conversion circuit.

On the other hand, an offset-free state can be implemented by forming the grayscale generation amplifier and the driver amplifier having a sample-hold function using a flip-around sample-hold circuit, for example, as described later. Therefore, since a highly accurate voltage can be supplied to the data line by minimizing a variation in the voltage output to the data line, the above-mentioned DAC drive operation becomes unnecessary. This makes it unnecessary to provide a D/A conversion circuit having an identical configuration corresponding to each data line. Therefore, one D/A conversion circuit can be shared by a plurality of data line driver circuits, as shown in FIGS. 2 and 3. This makes it possible to increase the accuracy of the voltage supplied to the data line while reducing the area of the data driver.

The configuration shown in FIGS. 2 and 3 also has an advantage in that a grayscale voltage line can be utilized for R (red), G (green), and B (blue) by time division.

In this embodiment, a grayscale data bus that connects the memory 20 and the data driver 50 shown in FIG. 1 is a 16-bit bus, for example. The number of bits of each of R, G, and B subpixels is 8 bits. The number of bits of a pixel formed by the R, G and B subpixels is 24 (=8×3) bits.

As indicated by E1 and E2 in FIG. 4, 8-bit grayscale data of a subpixel R0 of a first pixel and 8-bit grayscale data of a subpixel R1 of a second pixel adjacent to the first pixel are transferred from the memory 20 to the data driver 50 through the 16-bit grayscale data bus.

As indicated by E3 in FIG. 4, the D/A conversion circuit 52 outputs the first grayscale voltage VG1 and the second grayscale voltage VG2 corresponding to the 8-bit grayscale data of the subpixel R0. As indicated by E4, the grayscale generation amplifier GA1 samples the first grayscale voltage VG1 and the second grayscale voltage VG2 in the sampling period TS1, and generates a grayscale voltage between the first grayscale voltage VG1 and the second grayscale voltage VG2.

As indicated by E5, the D/A conversion circuit 52 outputs the first grayscale voltage VG1 and the second grayscale voltage VG2 corresponding to the 8-bit grayscale data of the subpixel R1. As indicated by E6, the grayscale generation amplifier GA2 samples the first grayscale voltage VG1 and the second grayscale voltage VG2 in the sampling period TS2, and generates a grayscale voltage between the first grayscale voltage VG1 and the second grayscale voltage VG2.

As indicated by E7 and E8, 8-bit grayscale data of a subpixel G0 of the first pixel and 8-bit grayscale data of a subpixel G1 of the second pixel are transferred from the memory 20 to the data driver 50 through the 16-bit grayscale data bus.

As indicated by E9, the D/A conversion circuit 52 outputs the first grayscale voltage VG1 and the second grayscale voltage VG2 corresponding to the 8-bit grayscale data of the subpixel G0. As indicated by E10, the grayscale generation amplifier GA3 samples the first grayscale voltage VG1 and the second grayscale voltage VG2 in the sampling period TS3, and generates a grayscale voltage between the first grayscale voltage VG1 and the second grayscale voltage VG2.

As indicated by E11, the D/A conversion circuit 52 outputs the first grayscale voltage VG1 and the second grayscale voltage VG2 corresponding to the 8-bit grayscale data of the subpixel G1. As indicated by E12, the grayscale generation amplifier GA4 samples the first grayscale voltage VG1 and the second grayscale voltage VG2 in the sampling period TS4, and generates a grayscale voltage between the first grayscale voltage VG1 and the second grayscale voltage VG2. Grayscale data of subpixels B0 and B1 is transferred at E13 and E14, and the above-described process is performed.

It is unnecessary to separately provide R, G, and B grayscale voltage lines by thus transferring the grayscale data of the subpixels R0, R1, G0, G1, B0, and B1. Specifically, one grayscale voltage line can be used by time division for transferring the R, G, and B grayscale data. For example, the grayscale voltage line can be used for R at E1 and E2 in FIG. 4, can be used for G at E7 and E8, and can be used for B at E13 and E14.

For example, when sixty-four grayscale voltage lines are necessary for R, G, and B, respectively, 192 (=64×3) grayscale voltage lines must be provided when separately providing R, G, and B grayscale voltage lines.

According to this embodiment, since one grayscale voltage line is used for R, G, and B by time division, only sixty-four grayscale voltage lines are necessary. Therefore, the wiring area of the grayscale voltage lines can be significantly reduced so that the area of the integrated circuit device can be reduced.

3. Data Line Common Potential Setting

This embodiment employs a data line common potential setting method (equalization) in order to reduce power consumption. Specifically, the output lines of the driver amplifiers DA1 to DA6 are set at a common potential in the driver amplifier sampling period TDS, as indicated by E16 in FIG. 4.

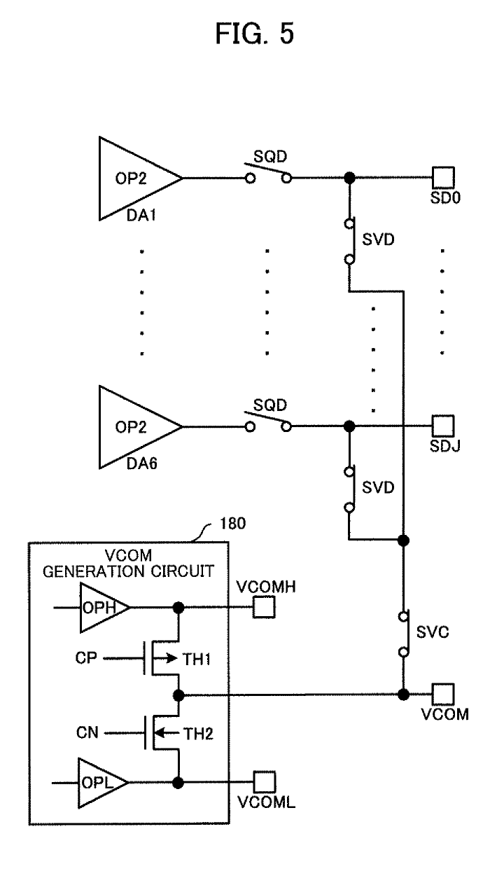

In FIG. 5, a VCOM generation circuit 180 (common voltage generation circuit) generates and outputs a common voltage VCOM (common electrode voltage) supplied to a common electrode of the pixels of the display panel, for example. The common voltage VCOM generated by the VCOM generation circuit 180 is supplied to the common electrode of the display panel through a VCOM pad (bump).

Specifically, the VCOM generation circuit 180 outputs a high-potential-side common voltage VCOMH or a low-potential-side common voltage VCOML as the common voltage VCOM based on a polarity inversion signal (not shown). For example, when performing line inversion drive, the polarity of a voltage applied to a liquid crystal element is reversed every scan period. Therefore, the VCOM generation circuit 180 selectively outputs the high-potential-side common voltage VCOMH or the low-potential-side common voltage VCOML corresponding to each scan period.

In FIG. 5, the output lines of the driver amplifiers DA1 to DA6 are set at the common voltage VCOM (common potential) in the driver amplifier sampling period TDS, as indicated by E16 in FIG. 4. Specifically switch elements SVD shown in FIG. 5 are turned ON in the driver amplifier sampling period so that the data lines (i.e., the output lines of the driver amplifiers DA1 to DA6) are set at the common voltage VCOM. Note that the common potential is not limited to the common voltage VCOM, but may be a GND potential or the like.

According to the configuration shown in FIG. 5, since the data lines of the display panel are charged and discharged by recycling a charge stored in the display panel, power consumption can be further reduced.

Output switch elements SQD of the driver amplifiers DA1 to DA6 are turned OFF in the driver amplifier sampling period TDS so that the outputs of the driver amplifiers DA1 to DA6 are set in a high impedance state (described later). Therefore, the data lines can be efficiently set at the common voltage VCOM by utilizing the period TDS in which the outputs of the driver amplifiers DA1 to DA6 are set in a high impedance state. Moreover, a situation in which the driver amplifiers DA1 to DA6 are adversely affected by setting the data lines at the common voltage VCOM can be prevented.

4. Switch Circuit

Various modifications of the data driver according to this embodiment are described below. In the following description, the data line driver circuits 60-1 to 60-N, the grayscale generation amplifiers 62-1 to 62-N, and the driver amplifiers 64-1 to 64-N that share the D/A conversion circuit 52 are respectively referred to as a data line driver circuit 60, a grayscale generation amplifier 62, and a driver amplifier 64 for convenience of illustration.

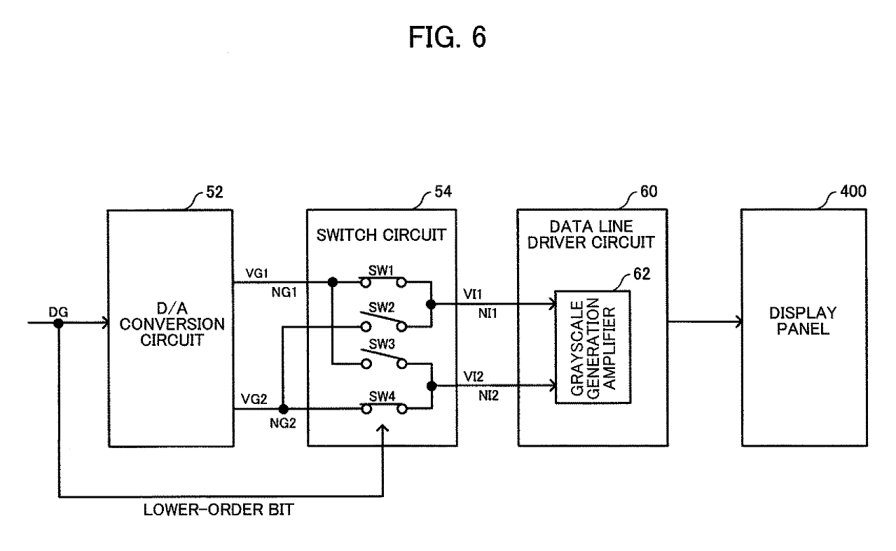

FIG. 6 shows a first modification of the data driver according to this embodiment. In the first modification shown in FIG. 6, a switch circuit 54 is additionally provided in the data driver.

Specifically, the D/A conversion circuit 52 receives a plurality of grayscale voltages (e.g., V0 to V128 or V0 to V64) from the grayscale voltage generation circuit 110 shown in FIG. 1 through grayscale voltage lines. The D/A conversion circuit 52 selects and outputs the first grayscale voltage VG1 and the second grayscale voltage VG2 corresponding to the grayscale data DG from the plurality of grayscale voltages. In this case, the first grayscale voltage VG1 and the second grayscale voltage VG2 output from the D/A conversion circuit 52 are consecutive (adjacent) grayscale voltages. Specifically, the first grayscale voltage VG1 and the second grayscale voltage VG2 are consecutive grayscale voltages (e.g., V0 and V1, V1 and V2, or V2 and V3) among a plurality of grayscale voltages (V0 to V128 or V0 to V64) input to the D/A conversion circuit 52 through the grayscale voltage lines.

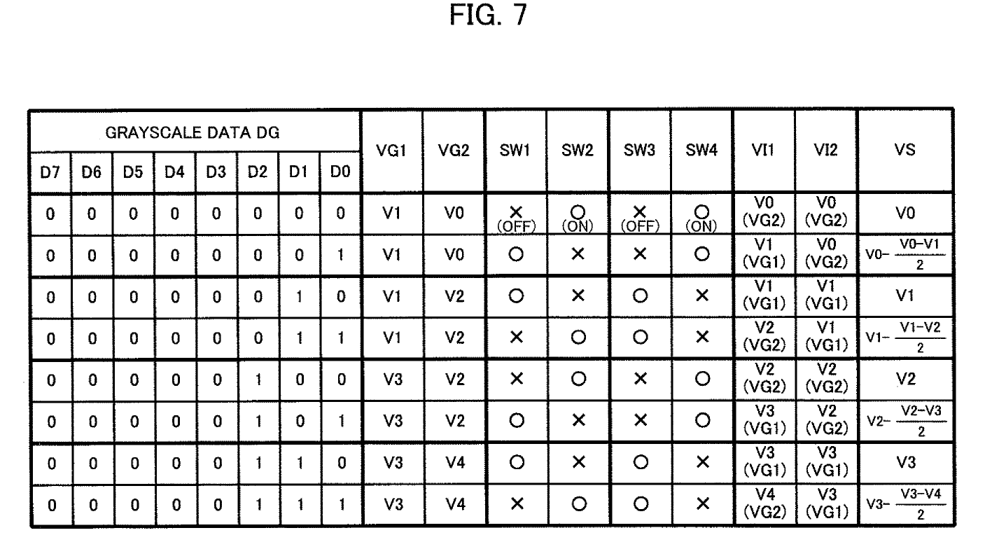

In FIG. 7, the grayscale data DG is 8-bit (256 grayscales) data (D7 to D0), for example. A plurality of grayscale voltages V0 to V128 are input to the D/A conversion circuit 52. In this example, the grayscale voltages V0 to V128 have a monotonically decreasing relationship (i.e., V0>V1>V2 . . . V127>V128). Note that the grayscale voltages V0 to V128 may have a monotonically increasing relationship (i.e., V0<V1<V2 . . . V127<V128).

The D/A conversion circuit 52 outputs the grayscale voltage V1 and the grayscale voltage V0 as the first grayscale voltage VG1 and the second grayscale voltage VG2 (i.e., VG1=V1 and VG2=V0), respectively, when the grayscale data DG (D7 to D0) is (00000000) or (00000001), and outputs the grayscale voltage V1 and the grayscale voltage V2 as the first grayscale voltage VG1 and the second grayscale voltage VG2 (i.e., VG1=V1 and VG2=V2), respectively, when the grayscale data DG (D7 to D0) is (00000010) or (00000011). The D/A conversion circuit 52 outputs the grayscale voltage V3 and the grayscale voltage V2 as the first grayscale voltage VG1 and the second grayscale voltage VG2 (i.e., VG1=V3 and VG2=V2), respectively, when the grayscale data DG (D7 to D0) is (00000100) or (00000101), and outputs the grayscale voltage V3 and the grayscale voltage V4 as the first grayscale voltage VG1 and the second grayscale voltage VG2 (i.e., VG1=V3 and VG2=V4), respectively, when the grayscale data DG (D7 to D0) is (00000110) or (00000111).

The D/A conversion circuit 52 thus outputs consecutive grayscale voltages corresponding to the grayscale data DG among the grayscale voltages V0 to V128 input from the grayscale voltage generation circuit 110 as the first grayscale voltage VG1 and the second grayscale voltage VG2. Although FIGS. 6 and 7 illustrate an example in which the D/A conversion circuit 52 generates two grayscale voltages (i.e., first grayscale voltage VG1 and second grayscale voltage VG2), the types (number) of grayscale voltages output from the D/A conversion circuit 52 are not limited thereto.

The data line driver circuit 60 (data line driver circuits 60-1 to 60-N) is a circuit that drives the data line of the display panel 400, and includes a grayscale generation amplifier 62 (grayscale generation amplifiers 62-1 to 62-N). The grayscale generation amplifier 62 (grayscale generation sample-hold circuit) generates and outputs a grayscale voltage between the first grayscale voltage VG1 and the second grayscale voltage VG2.

In FIG. 7, when the grayscale data DG is (00000001), the grayscale generation amplifier 62 generates (samples) and outputs the voltage (V0−(V0—V1)/2) between the first grayscale voltage VG1 (=V1) and the second grayscale voltage VG2 (=V0) as a grayscale voltage VS. When the grayscale data DG is (00000000), the grayscale generation amplifier 62 outputs the grayscale voltage V0 (=VG2) as the grayscale voltage VS. When the grayscale data DG is (00000011), the grayscale generation amplifier 62 generates and outputs the voltage (V1−(V1−V2)/2) between the first grayscale voltage VG1 (=V1) and the second grayscale voltage VG2 (=V2) as the grayscale voltage VS. When the grayscale data DC is (00000010), the grayscale generation amplifier 62 outputs the grayscale voltage V1 (=VG1) as the grayscale voltage VS.

The switch circuit 54 is provided between the D/A conversion circuit 52 and the data line driver circuit 60. The switch circuit 54 may be an element of the D/A conversion circuit 52 or the data line driver circuit 60.

The switch circuit 54 includes a plurality of switch elements. In FIG. 6, the switch circuit 54 includes a first switch element SW1 to a fourth switch element SW4, for example. Note that the number of switch elements is not limited to four, but may be eight, sixteen, or the like (described later). The switch elements SW1 to SW4 may be formed by CMOS transistors. Specifically, the switch elements SW1 to SW4 may be formed by transfer gates including a P-type transistor and an N-type transistor. These transistors are turned ON/OFF based on switch control signals output from a switch control signal generation circuit (not shown).

The switch element SW1 is provided between a first voltage output node NG1 (i.e., output node of the first grayscale voltage VG1) of the D/A conversion circuit 52 and a first input node NI1 of the grayscale generation amplifier 62 (data line driver circuit 60). The switch element SW2 is provided between a second voltage output node NG2 (i.e., output node of the second grayscale voltage VG2) of the D/A conversion circuit 52 and the input node NI1 of the grayscale generation amplifier 62. The switch element SW1 and the switch element SW2 are exclusively turned ON/OFF. As shown in FIG. 7, the switch element SW1 is turned OFF and the switch element SW2 is turned ON when the grayscale data DG is (00000000), and the switch element SW1 is turned ON and the switch element SW2 is turned OFF when the grayscale data DG is (00000001), for example.

The switch element SW3 is provided between the voltage output node NG1 of the D/A conversion circuit 52 and an input node NI2 of the grayscale generation amplifier 62. The switch element SW4 is provided between the voltage output node NG2 of the D/A conversion circuit 52 and the input node NI2 of the grayscale generation amplifier 62. The switch element SW3 and the switch element SW4 are exclusively turned ON/OFF. For example, the switch element SW3 is turned OFF and the switch element SW4 is turned ON when the grayscale data DG is (00000001), and the switch element SW3 is turned ON and the switch element SW4 is turned OFF when the grayscale data DG is (00000010).

As shown in FIG. 7, when the grayscale data DG is (00000000), the D/A conversion circuit 52 outputs the grayscale voltage V1 and the grayscale voltage V0 as the first grayscale voltage VG1 and the second grayscale voltage VG2, respectively. The switch elements SW1, SW2, SW3, and SW4 of the switch circuit 54 are turned OFF, ON, OFF, and ON, respectively. Therefore, a grayscale voltage VI1 (=VG2=V0) and a grayscale voltage VI2 (=VG2=V0) are respectively input to the input node NI1 and the input node NI2 of the grayscale generation amplifier 62. The grayscale generation amplifier 62 thus outputs the grayscale voltage V0 as the grayscale voltage VS (sampling voltage).

When the grayscale data DG is (00000001), the switch elements SW1, SW2, SW3, and SW4 are turned ON, OFF, OFF, and ON, respectively. Therefore, the grayscale voltage VI1 (=VG1=V1) and the grayscale voltage VI2 (=VG2=V0) are respectively input to the input node NI1 and the input node NI2 of the grayscale generation amplifier 62 so that the grayscale generation amplifier 62 outputs the voltage (V0−(V0−V1)/2) as the grayscale voltage VS. Specifically, the grayscale generation amplifier 62 outputs the grayscale voltage corresponding to the grayscale data DG (=(00000001)).

When the grayscale data DG is (00000010), the D/A conversion circuit 52 outputs the grayscale voltage V1 and the grayscale voltage V2 as the first grayscale voltage VG1 and the second grayscale voltage VG2, respectively. The switch elements SW1, SW2, SW3, and SW4 are turned ON, OFF, ON, and OFF, respectively. Therefore, the grayscale voltage VI1 (=VG1=V1) and the grayscale voltage VI2 (=VG1=V1) are respectively input to the input node NI1 and the input node NI2 of the grayscale generation amplifier 62 so that the grayscale generation amplifier 62 outputs the grayscale voltage V1 as the grayscale voltage VS.

When the grayscale data DG is (00000011), the switch elements SW1, SW2, SW3, and SW4 are turned OFF, ON, ON, and OFF, respectively. Therefore, the grayscale voltage VI1 (=VG2=V2) and the grayscale voltage VI2 (=VG1=V1) are respectively input to the input node NI1 and the input node NI2 of the grayscale generation amplifier 62 so that the grayscale generation amplifier 62 outputs the voltage (V1−(V1−V2)/2) as the grayscale voltage VS. Specifically, the grayscale generation amplifier 62 outputs the grayscale voltage corresponding to the grayscale data DG (=(00000011)).

As shown in FIG. 7, the switch elements SW1 to SW4 are turned ON/OFF based on the lower-order bits of the grayscale data DG. Specifically, the switch elements SW1 to SW4 are turned ON/OFF based on switch control signals generated based on the lower-order bits of the grayscale data DG. For example, when the lower-order bits D1 and D0 of the grayscale data DG are (00), the switch elements SW1, SW2, SW3, and SW4 are turned OFF, ON, OFF, and ON, respectively, as shown in FIG. 7. When the lower-order bits D1 and D0 of the grayscale data D0 are (01), the switch elements SW1, SW2, SW3, and SW4 are turned ON, OFF, OFF, and ON, respectively. When the lower-order bits D1 and D0 of the grayscale data D0 are (10), the switch elements SW1, SW2, SW3, and SW4 are turned ON, OFF, ON, and OFF, respectively. When the lower-order bits D1 and D0 of the grayscale data DG are (11), the switch elements SW1, SW2, SW3, and SW4 are turned OFF, ON, ON, and OFF, respectively.

Since the above-described data driver according to this embodiment can generate the grayscale voltage using the grayscale generation amplifier 62, the number (types) of grayscale voltages generated by the grayscale voltage generation circuit 110 shown in FIG. 1 can be reduced. This makes it possible to reduce the number of grayscale voltage lines while reducing the circuit scale of the D/A conversion circuit 52.

For example, when the number of bits of the grayscale data DG is eight (i.e., the number of grayscales is 2⁸ (=256)), the grayscale voltage generation circuit 110 must generate 256 grayscale voltages when using a related-art method. Therefore, the D/A conversion circuit 52 must include selectors that select the grayscale voltages corresponding to the grayscale data DG from the 256 grayscale voltages. This increases the circuit scale of the grayscale voltage generation circuit 110 and the D/A conversion circuit 52. Moreover, since 256 grayscale voltage lines are required, the wiring area increases.

On the other hand, since the data driver according to this embodiment shown in FIG. 6 generates the grayscale voltage using the grayscale generation amplifier 62, it suffices that the grayscale voltage generation circuit 110 generate 128 grayscale voltages, for example. Therefore, it suffices that the D/A conversion circuit 52 include selectors that select voltages from the 128 grayscale voltages. Accordingly, the circuit scale can be significantly reduced as compared with the related-art method. Moreover, since the number of grayscale voltage lines can be reduced to 128, the wiring area can be significantly reduced. Note that 129 (=128+1) grayscale voltage lines are required in the above-described case since the grayscale generation amplifier 62 generates a voltage by dividing the voltage between the first grayscale voltage VG1 and the second grayscale voltage VG2.

According to the data driver shown in FIG. 6, the grayscale generation amplifier 62 has a sample-hold function. Therefore, a voltage that varies to only a small extent can be supplied to the data line without performing a DAC drive operation in which the D/A conversion circuit 52 directly drives the data line. Specifically, an accurate voltage can be supplied to the data line by a relatively small and simple circuit configuration. Since the grayscale generation amplifier 62 has a sample-hold function, a plurality of data line driver circuits 60 can share one D/A conversion circuit 52. Therefore, the circuit scale can be further reduced.

According to the data driver shown in FIG. 6, the switch circuit 54 is provided between the D/A conversion circuit 52 and the data line driver circuit 60. Therefore, the input voltages (VI1, VI2)=(V1, V0), (V, V0), (V1, V1), (V2, V1), . . . can be input to the grayscale generation amplifier 62 (see FIG. 7) based on the first grayscale voltage VG1 and the second grayscale voltage VG2 output from the D/A conversion circuit 52, for example. As a result, the grayscale generation amplifier 62 can output the grayscale voltage that decreases monotonically (or increases monotonically) (e.g., VS=V0, V0−(V0−V1)/2, V1, V1−(V1−V2)/2, V2, . . . ) so that an appropriate grayscale voltage can be output by a simple circuit configuration.

5. Flip-Around Sample-Hold Circuit

The grayscale generation amplifier 62 may be formed by a flip-around sample-hold circuit. The term. “flip-around sample-hold circuit” refers to a circuit that samples a charge corresponding to an input voltage using a sampling capacitor in a sampling period, and performs a flip-around operation of the sampling capacitor in a holding period to output a voltage corresponding to the stored charge to its output node, for example.

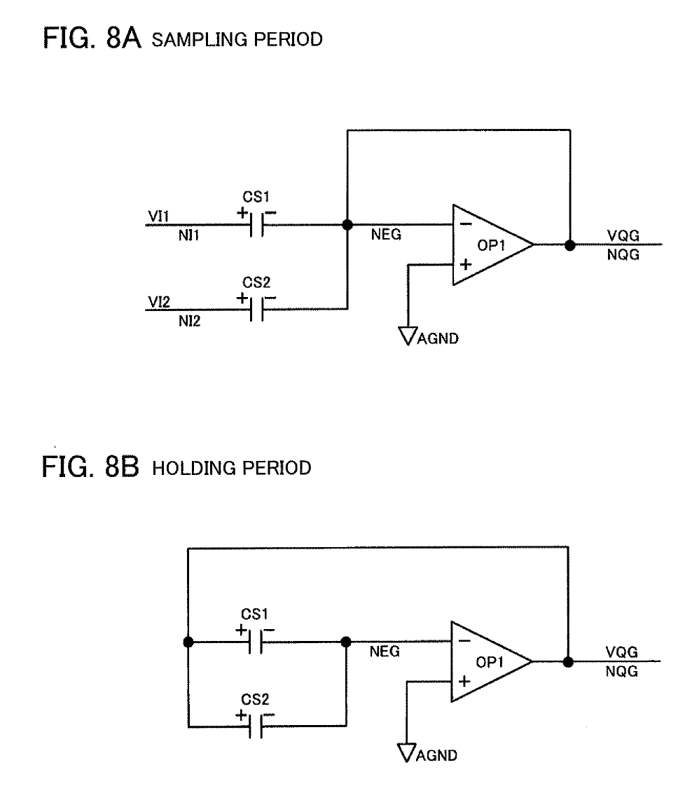

The flip-around sample-hold circuit is described in detail below with reference to FIGS. 8A and 8B.

In FIGS. 8A and 8B, the grayscale generation amplifier 62 formed by a flip-around sample-hold circuit includes an operational amplifier OP1 and first and second sampling capacitors CS1 and CS2 (a plurality of sampling capacitors), for example.

The sampling capacitor CS1 is provided between an inverting input terminal (first input terminal in a broad sense) of the operational amplifier OP1 and the input node NI1 of the grayscale generation amplifier 62. As shown in FIG. 8A the capacitor CS1 stores a charge corresponding to the input voltage VI1 at the input node NI1 in the sampling period.

The sampling capacitor CS2 is provided between the inverting input terminal of the operational amplifier OP1 and the input node NI2 of the grayscale generation amplifier 62. The capacitor CS2 stores a charge corresponding to the input voltage VI2 at the input node NI2 in the sampling period.

As shown in FIG. 8A the output from the operational amplifier OP1 is fed back to a node NEG of the inverting input terminal of the operational amplifier OP1 in the sampling period. A non-inverting input terminal (second input terminal in a broad sense) of the operational amplifier OP1 is set at an analog reference voltage AGND. Therefore, the node NEG connected to one end of the capacitors CS1 and CS2 is set at the analog reference voltage AGND due to a virtual short-circuit function of the operational amplifier OP1. As a result, charges corresponding to the input voltages VI1 and VI2 are respectively stored in the capacitors CS1 and CS2.

In the holding period, the grayscale generation amplifier 62 outputs an output voltage VQG (=VS) corresponding to the charges stored in the sampling capacitors CS1 and CS2 in the sampling period to an output node NQG, as shown in FIG. 8B. Specifically, the grayscale generation amplifier 62 outputs the output voltage VQG corresponding to the charges stored in the sampling capacitors CS1 and CS2 by performing a flip-around operation that connects the other end of the capacitors CS1 and CS2 connected to the node NEG at one end to an output terminal of the operational amplifier OP1.

An offset-free state can be implemented by forming the grayscale generation amplifier 62 using the above-described flip-around sample-hold circuit.

For example, an offset voltage generated between the inverting input terminal and the non-inverting input terminal of the operational amplifier OP1 is referred to as VOF, the analog reference voltage AGND is set at 0 V, the input voltages in the sampling period are set at VI1=VI2=V1, and the parallel capacitance of the capacitors CS1 and CS2 (connected in parallel) is referred to as CS. In this case, a charge Q stored in the sampling period is expressed by the following equation.

Q=(VI−VOF)×CS (1)

When the voltage of the node NEG in the holding period is referred to as VX and the output voltage is referred to as VQG, a charge Q′ stored in the holding period is expressed by the following equation.

Q′=(VQG−VX)×CS (2)

When the amplification factor of the operational amplifier OP1 is referred to as A, the output voltage VQG is expressed by the following equation.

VQG=−A×(VX−VOF) (3)

Since Q=Q′ is satisfied according to the principle of charge conservation, the following equation is satisfied.

(VI−VOF)×CS−(VQG−VX)×CS (4)

Therefore, the following equation is satisfied from the equations (3) and (4).

VQG=VI−VOF+VX=VI−VOF+VOF−VQG/A

Therefore, the output voltage VQG of the grayscale generation amplifier 62 is expressed by the following equation.

VQG={1/(1+1/A)}×VI (5)

As is clear from the equation (5), since the output voltage VQG of the grayscale generation amplifier 62 is independent of the offset voltage VOF so that an offset can be canceled, an offset-free state can be implemented.

For example, when a plurality of data line driver circuits 60 drive a plurality of data lines, the output voltage VQG varies between the data lines when the offset voltage VOF is involved in the output voltage VQG, whereby the display quality deteriorates.

On the other hand, since an offset can be canceled by utilizing the flip-around sample-hold circuit, a variation in the output voltage VQG between the data lines can be minimized. Therefore, an accurate voltage that varies to only a small extent can be supplied to the data line so that the display quality can be improved. Moreover, since a DAC drive operation that directly drives the data line using the D/A conversion circuit 52 becomes unnecessary, high-speed drive and simplified control can be implemented.

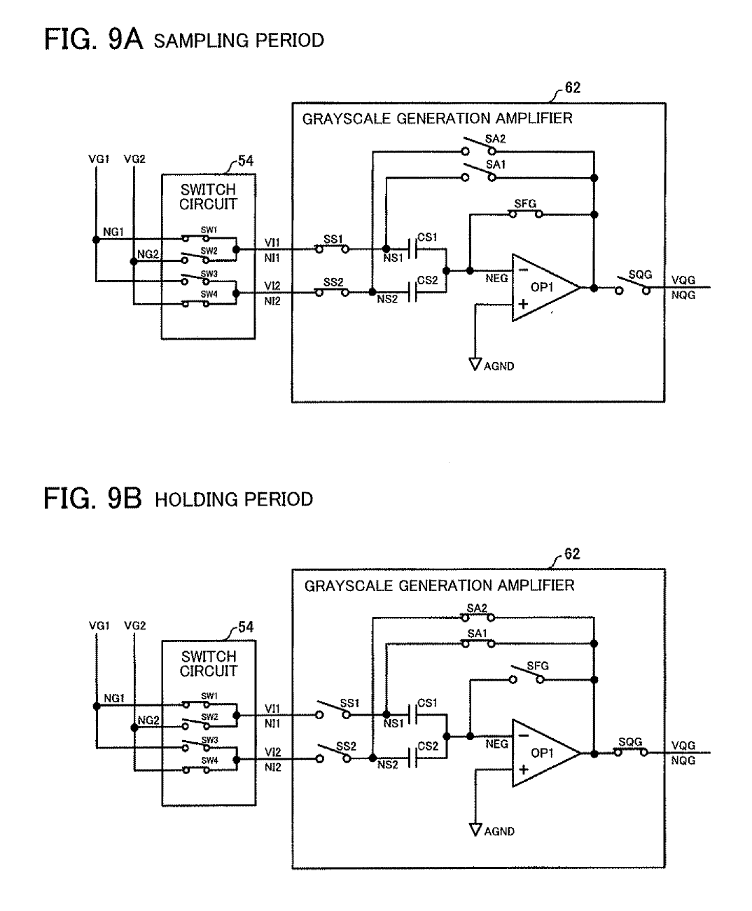

FIGS. 9A and 9B show a specific configuration example of the grayscale generation amplifier 62 using the flip-around sample-hold circuit.

The grayscale generation amplifier 62 shown in FIGS. 9A and 9B includes the operational amplifier OP1, first and second sampling switch elements SS1 and SS2, the first and second sampling capacitors CS1 and CS2, a feedback switch element SFG, and first and second flip-around switch elements SA1 and SA2. The grayscale generation amplifier 62 also includes an output switch element SQG. Note that modifications may be made such as omitting some of the elements or adding other elements. The switch elements SS1, SS2, SA1, SA2, SFG, and SQG may be formed by CMOS transistors (e.g., transfer gate), for example.

The non-inverting input terminal (second input terminal) of the operational amplifier OP1 is set at the analog reference voltage AGND (given reference voltage in a broad sense).

The sampling switch element SS1 and the sampling capacitor CS1 are provided between the input node NI1 of the grayscale generation amplifier 62 and the inverting input terminal (first input terminal) of the operational amplifier OP. The sampling switch element SS2 and the sampling capacitor CS2 are provided between the input node NI2 of the grayscale generation amplifier 62 and the inverting input terminal of the operational amplifier OP1.

The feedback switch element SFG is provided between the output terminal and the inverting input terminal of the operational amplifier OP1.

The flip-around switch element SA1 is provided between a first connection node NS1 situated between the switch element SS1 and the capacitor CS1 and the output terminal of the operational amplifier OP1. The flip-around switch element SA2 is provided between a second connection node NS2 situated between the switch element SS2 and the capacitor CS2 and the output terminal of the operational amplifier OP1.

In the sampling period, the sampling switch elements SS1 and SS2 and the feedback switch element SFG are turned ON, and the flip-around switch elements SA1 and SA2 are turned OFF, as shown in FIG. 9A. This implements the sampling operation of the flip-around sample-hold circuit described with reference to FIG. 8A

In the holding period, the sampling switch elements SS1 and SS2 and the feedback switch element SFG are turned OFF, and the flip-around switch elements SA1 and SA2 are turned ON, as shown in FIG. 9B. This implements the holding operation of the flip-around sample-hold circuit described with reference to FIG. 8B.

The output switch element SQG is provided between the output terminal of the operational amplifier OP1 and the output node NQG of the grayscale generation amplifier 62. In the sampling period, the output switch element SQG is turned OFF, as shown in FIG. 9A. This causes the output of the grayscale generation amplifier 62 to be set in a high impedance state so that a situation in which an indefinite voltage in the sampling period is transmitted to the subsequent stage can be prevented.

In the holding period, the output switch element SQG is turned ON, as shown in FIG. 9B. Therefore, the voltage VQG (i.e., the grayscale voltage generated in the sampling period) can be output.

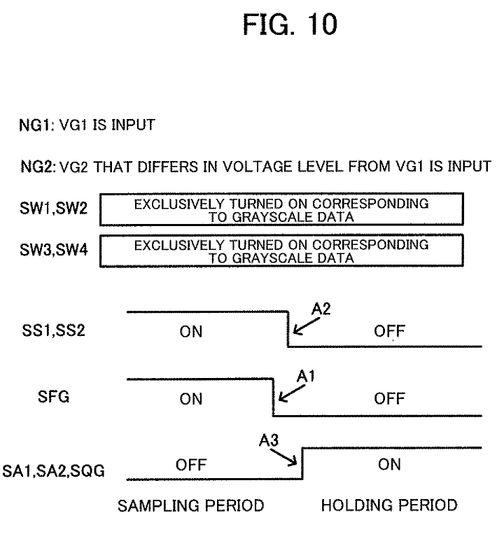

The operation of the circuit shown in FIGS. 9A and 9B is described below with reference to FIG. 10. The first grayscale voltage VG1 from the D/A conversion circuit 52 is input to the node NG1, and the second grayscale voltage VG2 that differs in voltage level from the first grayscale voltage VG1 (as described with reference to FIG. 7) is input to the node NG2.

One of the switch elements SW1 and SW2 of the switch circuit 54 is exclusively turned ON corresponding to the grayscale data DG, as described with reference to FIG. 7. One of the switch elements SW3 and SW4 is exclusively turned ON corresponding to the grayscale data DG.

In the sampling period, switch control signals input to the sampling switch elements SS1 and SS2 and the feedback switch element SFG are activated (H level) so that the sampling switch elements SS1 and SS2 and the feedback switch element SFG are turned ON. On the other hand, switch control signals input to the flip-around switch elements SA1 and SA2 and the output switch element SQG are inactivated (L level) so that the flip-around switch elements SA1 and SA2 and the output switch element SQG are turned OFF.

In the holding period, the switch control signals input to the sampling switch elements SS1 and SS2 and the feedback switch element SFG are inactivated so that the sampling switch elements SS1 and SS2 and the feedback switch element SFG are turned OFF. On the other hand, the switch control signals input to the flip-around switch elements SA1 and SA2 and the output switch element SQG are activated so that the flip-around switch elements SA1 and SA2 and the output switch element SQG are turned ON.

The sampling switch elements SS1 and SS2 are turned OFF after the feedback switch element SFG has been turned OFF, as indicated by A1 and A2 in FIG. 10. This minimizes an adverse effect of charge injection, as described later. The flip-around switch elements SA1 and SA and the output switch element SQG are turned ON after the sampling switch elements SS1 and SS2 have been turned OFF, as indicated by A3.

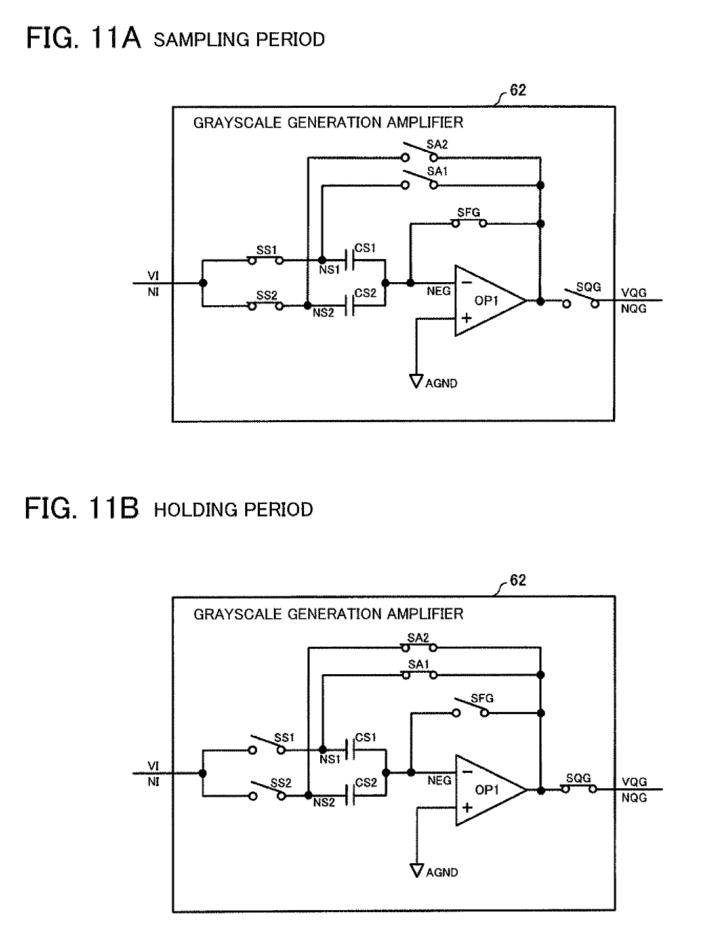

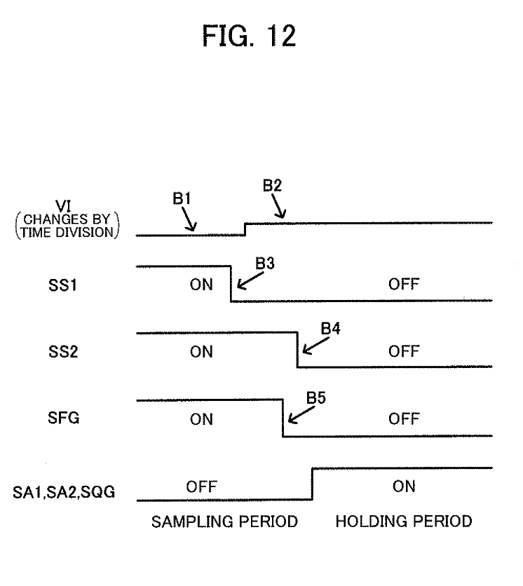

FIGS. 11A and 11B show a configuration of a grayscale generation amplifier as second configuration example of the grayscale generation amplifier, and FIG. 12 is a view illustrative of the circuit operation of the grayscale generation amplifier shown in FIGS. 11A and 11B.

In the second configuration example shown in FIGS. 11A and 11B, the first grayscale voltage and the second grayscale voltage from the D/A conversion circuit 52 are input to the grayscale generation amplifier 62 by time division in the sampling period, as indicated by B1 and B2 in FIG. 12. When the sampling switch element SS1 is turned OFF (B3 in FIG. 12), the first grayscale voltage input and sampled at B1 is held. When the sampling switch element SS2 is turned OFF (B4 in FIG. 12), the second grayscale voltage input and sampled at B2 is held.

In the second configuration example shown in FIGS. 11A to 12, since the sampling period is reduced as compared with FIGS. 9A to 10, a sufficient period of time may not be ensured for the sampling operation so that the accuracy of the output voltage VQG may deteriorate.

According to the configuration shown in FIGS. 9A to 10, since a sufficient sampling period can be provided, an accurate sample-hold operation can be implemented so that an accurate output voltage VQG can be output.

In the second configuration example, since the switch elements SS1 and SS2 must be turned OFF in time series, the switch element SS1 is turned OFF before the switch element SFG is turned OFF, as indicated by B3 and B5 in FIG. 12. Therefore, since the switch element SFG is set in an ON state (i.e., the node NEG is not set in a high impedance state) when the switch element SS1 is turned OFF, an adverse effect of charge injection or clock feedthrough via the switch element SS1 occurs.

According to the configuration shown in FIGS. 9A to 10, since the switches can be controlled at the timings indicated by A1, A2, and A3 in FIG. 10, an adverse effect of charge injection or the like can be minimized so that a variation in the output voltage VQG can be minimized.

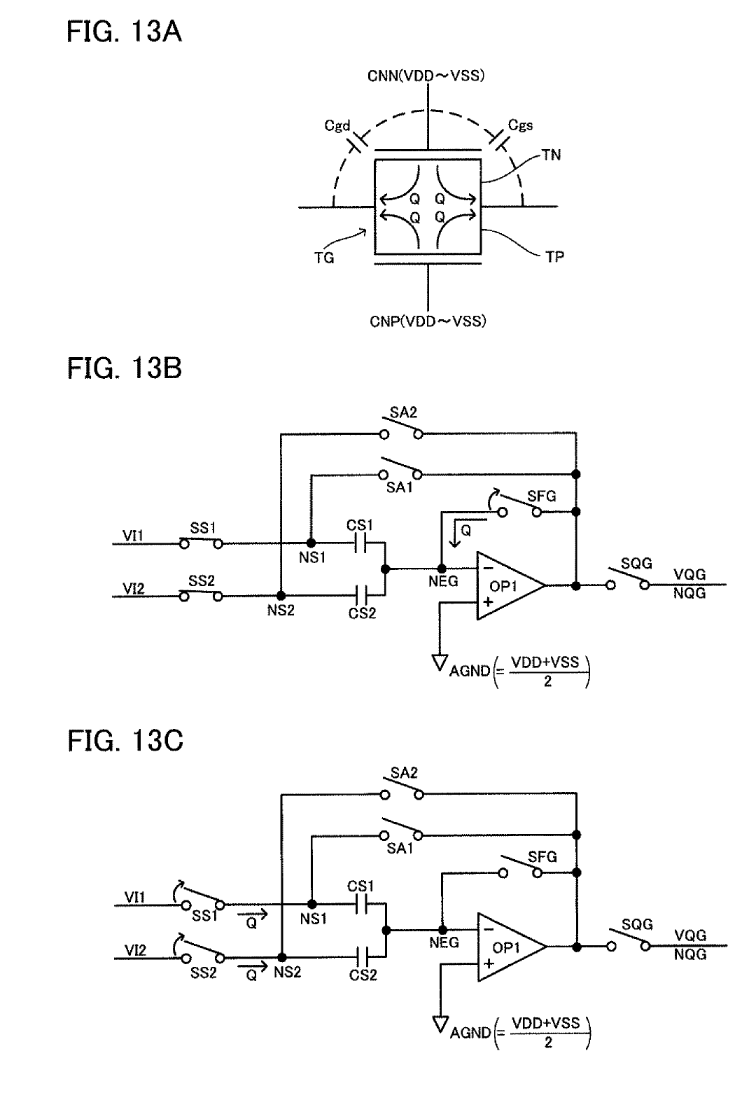

FIG. 13A shows an example of a transfer gate TG used as the switch element. Switch control signals CNN and CNP are respectively input to the gates of an N-type transistor TN and a P-type transistor TP that form the transfer gate TG. When the transfer gate TG is turned OFF, clock feedthrough occurs due to a gate-drain parasitic capacitor Cgd and a gate-source parasitic capacitor Cgs. When the transfer gate TG is turned OFF, a charge in the channel flows into the drain or the source (i.e., charge injection occurs).

According to this embodiment, since the sampling switch elements SS1 and SS2 are turned OFF (see FIG. 13C) after the feedback switch element SFG has been turned OFF (see FIG. 13B), an adverse effect of charge injection or clock feedthrough can be reduced as compared with the second configuration example shown in FIGS. 11A to 12.

Specifically, if the switch element SFG is turned OFF when the switch elements SS1 and SS2 are set in an ON state (see FIG. 13B), an adverse effect of charge injection or clock feedthrough via the switch element SFG occurs. However, the switch element SFG has been turned OFF (i.e., the node NEG has been set in a high impedance state) when the switch elements SS1 and SS2 are turned OFF (see FIG. 13C). Therefore, an adverse effect of charge injection or clock feedthrough via the switch elements SS1 and SS2 does not occur. As a result, an adverse effect of charge injection or clock feedthrough can be reduced as compared with the second configuration example.

The switch control signals CNN and CNP having an amplitude between VDD and VSS are input to the gates of the transistors TN and TP of the transfer gate TG shown in FIG. 13A. Therefore, when the potential of the drain or the source of the transfer gate TG is set at VSS or VDD, an imbalance occurs between the amount of charge from the N-type transistor TN and the amount of charge from the P-type transistor TP. As a result, a charge due to charge injection remains without being canceled.

According to this embodiment, the non-inverting input terminal of the operational amplifier OP1 is set at the analog reference voltage AGND (i.e., the intermediate voltage between the voltage supplied from the power supply VDD (second power supply in a broad sense) and the voltage supplied from the power supply VSS (first power supply in a broad sense) immediately before the switch element SFG is turned OFF (see FIG. 13B), and the potential of the node NEG is set at the analog reference voltage AGND (=(VDD+VSS)/2) due to the virtual short-circuit function of the operational amplifier OP1. Therefore, since the source and the drain of the switch element SFG are set at the analog reference voltage AGND (i.e., independent of the input grayscale voltage) immediately before the switch element SFG is turned OFF and an imbalance between the amount of charge from the N-type transistor TN and the amount of charge from the P-type transistor TP can be reduced, an adverse effect of charge injection that occurs when the switch element SFG is turned OFF can be minimized.

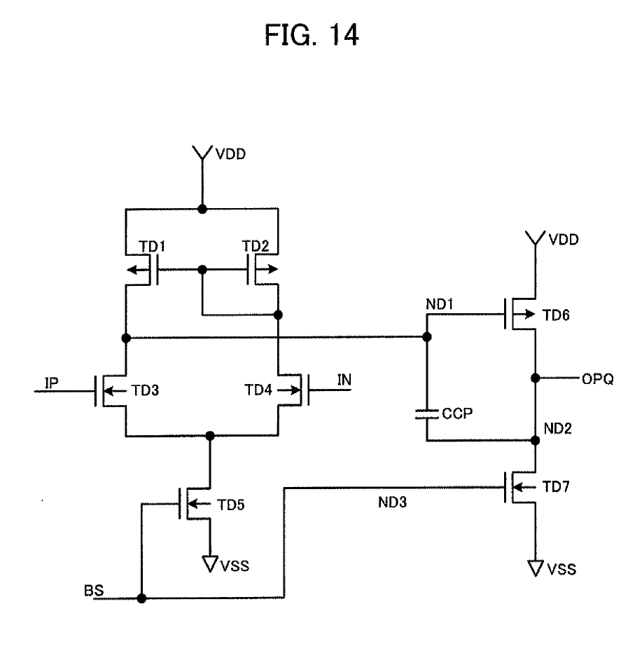

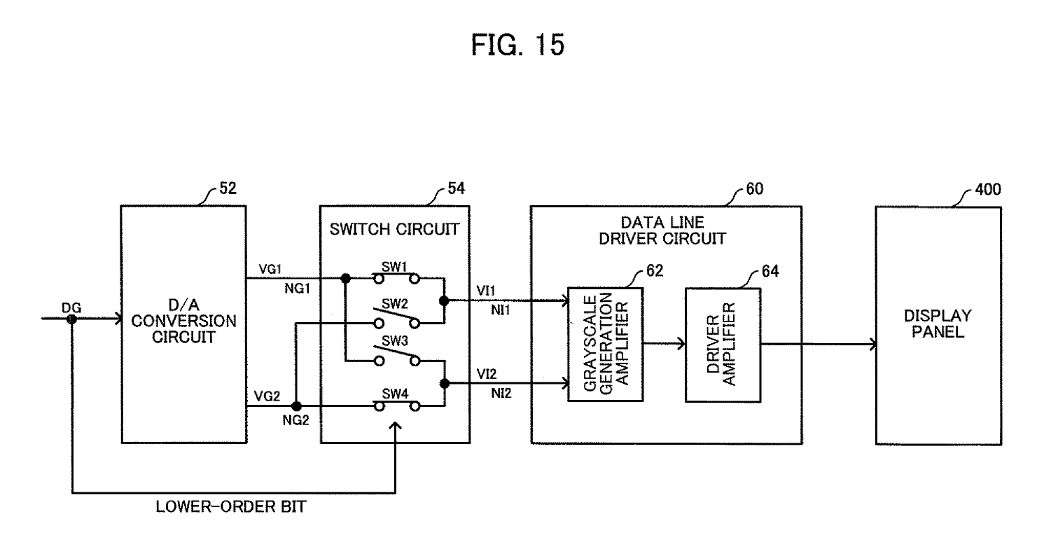

FIG. 14 shows a configuration example of the operational amplifier OP1. The operational amplifier OP1 performs a class A amplification operation. In FIG. 14, a differential section (differential stage) of the operational amplifier OP1 is formed by transistors TD1, TD2, TD3, TD4, and TD5, and an output section (output stage) of the operational amplifier OP1 is formed by transistors TD6 and TD7. In FIG. 14, a phase-compensation capacitor CCP is provided between an output node ND1 of the differential section and an output node ND2 of the operational amplifier OP1.

6. Driver Amplifier

FIG. 15 shows a second modification of the data driver. FIG. 15 differs from FIG. 6 in that the data line driver circuit 60 further includes a driver amplifier 64 (driver amplifier 64-1˜64-N).

The driver amplifier 64 (driver sample-hold circuit or output amplifier) is provided in the subsequent stage of the grayscale generation amplifier 62, and drives the data line of the display panel 400. The driver amplifier 64 may also be formed by the flip-around sample-hold circuit described with reference to FIGS. 8A and 8B. According to this configuration, since a variation in the output voltage of the driver amplifier 64 can be minimized due to the offset cancellation function of the flip-around sample-hold circuit, the display quality can be improved.

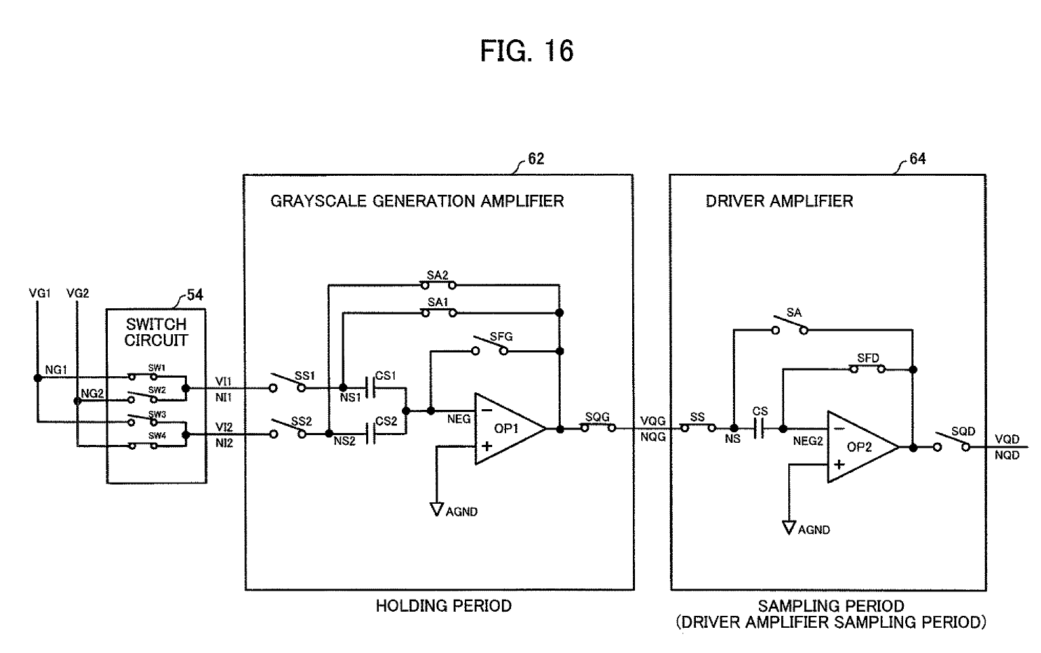

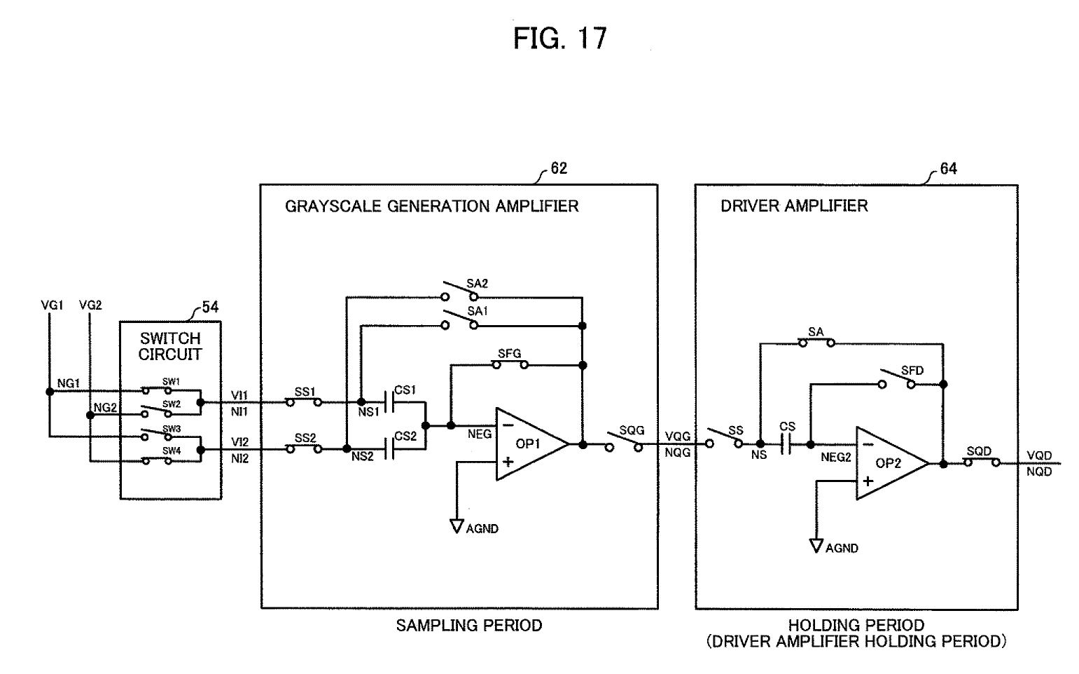

FIGS. 16 and 17 show a specific configuration example of the driver amplifier 64. Note that the configuration of the driver amplifier 64 is not limited to the configuration shown in FIGS. 16 and 17. Various modifications may be made such as omitting some of the elements or adding other elements.

The driver amplifier 64 includes a second operational amplifier OP2 and a sampling capacitor CS. The sampling capacitor CS is provided between an inverting input terminal (first input terminal) of the operational amplifier OP2 and an input node NQG of the driver amplifier 64.

As shown in FIG. 16, a charge corresponding to the input voltage VQG at the input node NQG is stored in the sampling capacitor CS in a driver amplifier sampling period. Specifically, the grayscale generation amplifier 62 performs the holding operation in the driver amplifier sampling period, and outputs the voltage VQG corresponding to a charge stored in the sampling period. The driver amplifier 64 samples the output voltage VQG in the driver amplifier sampling period.

The driver amplifier 64 outputs an output voltage VQD corresponding to a charge stored in the capacitor CS in the driver amplifier sampling period shown in FIG. 16 in a driver amplifier holding period, as shown in FIG. 17. In the driver amplifier holding period, the grayscale generation amplifier 62 performs the sampling operation, and the output switch element SQG has been turned OFF.

The driver amplifier 64 includes the operational amplifier OP2, a sampling switch element SS, the sampling capacitor CS, a second feedback switch element SFD, and a flip-around switch element SA. The driver amplifier 64 also includes an output switch element SQD.

A non-inverting input terminal (second input terminal) of the operational amplifier OP2 is set at the analog reference voltage AGND (given reference voltage).

The sampling switch element SS and the sampling capacitor CS are provided between the input node NQG of the driver amplifier 64 and the inverting input terminal (first input terminal) of the operational amplifier OP2. The feedback switch element SFD is provided between the output terminal and the inverting input terminal of the operational amplifier OP2.

The flip-around switch element SA is provided between a connection node NS situated between the switch element SS and the capacitor CS and the output terminal of the operational amplifier OP2. The output switch element SQD is provided between the output terminal of the operational amplifier OP2 and an output node NQD of the driver amplifier 64.

In the driver amplifier sampling period, the sampling switch element SS and the feedback switch element SFD are turned ON, and the flip-around switch element SA is turned OFF, as shown in FIG. 16. This implements the sampling operation of the flip-around sample-hold circuit.

In the driver amplifier holding period, the sampling switch element SS and the feedback switch element SFD are turned OFF, and the flip-around switch element SA is turned ON, as shown in FIG. 17. This implements the holding operation of the flip-around sample-hold circuit.

In the driver amplifier sampling period, the output switch element SQD is turned OFF, as shown in FIG. 16. This causes the output of the driver amplifier 64 to be set in a high impedance state so that a situation in which an indefinite voltage in the sampling period is transmitted to the subsequent stage can be prevented. In the driver amplifier holding period, the output switch element SQD is turned ON, as shown in FIG. 17. Therefore, the voltage sampled in the sampling period can be output to the subsequent stage.

The voltage VQG output from the grayscale generation amplifier 62 in the holding period can be sampled in the driver amplifier sampling period (see FIG. 16) by providing the above-described driver amplifier 64. The driver amplifier 64 can output the voltage VQD corresponding to the voltage VQG to the data line instead of the grayscale generation amplifier 62 in the sampling period of the grayscale generation amplifier 62 (see FIG. 17).

For example, when the sampling period of the grayscale generation amplifier 62 is increased, since the data line cannot be driven in the sampling period of the grayscale generation amplifier 62 because the output of the grayscale generation amplifier 62 is set in a high impedance state so that a sufficient drive time cannot be ensured.

On the other hand, when providing the driver amplifier 64 shown in FIGS. 16 and 17, the driver amplifier 64 is set in a holding operation mode in the sampling period of the grayscale generation amplifier 62 so that the data line can be driven. This enables the drive time to be increased so that the display quality can be improved.

In particular, when a plurality of data line driver circuits 60 share one D/A conversion circuit 52 and the D/A conversion circuit 52 supplies the grayscale voltages to the data line driver circuits 60 by time division, the total time of the sampling periods of the data line driver circuits 60 increases to a large extent.

On the other hand, when providing the driver amplifier 64 shown in FIGS. 16 and 17, the driver amplifier 64 is set in the holding operation mode in the sampling periods of the data line driver circuits 60 so that the data line can be driven. Therefore, a highly accurate voltage can he supplied to the data line so that the display quality can be improved.

When providing the driver amplifier 64 in addition to the grayscale generation amplifier 62, the operational amplifier OP1 included in the grayscale generation amplifier 62 may be formed by an amplifier that performs a class A amplification operation, and the operational amplifier OP2 included in the driver amplifier 64 may be formed by an amplifier that performs a class AB amplification operation, for example. Specifically, the operational amplifier OP2 is formed by an amplifier that performs a class A amplification operation in the sampling period and performs a class AB amplification operation in the holding period.

For example, the operational amplifier OP1 shown in FIG. 14 that forms the grayscale generation amplifier 62 is an amplifier that performs a class A amplification operation. The circuit can be simplified and power consumption can be easily reduced by utilizing the amplifier that performs a class A amplification operation. When providing the driver amplifier 64 in the subsequent stage of the grayscale generation amplifier 62, since the drive load of the grayscale generation amplifier 62 consists only of the sampling capacitor CS and the like of the driver amplifier 64 (i.e., the drive load is low), the driver amplifier 64 can be driven normally.

On the other hand, since the driver amplifier 64 must drive the data line having a large parasitic capacitance in the holding period, the drive load of the driver amplifier 64 is high. Therefore, the operational amplifier OP2 of the driver amplifier 64 is formed by an amplifier that can perform a class AB amplification operation.

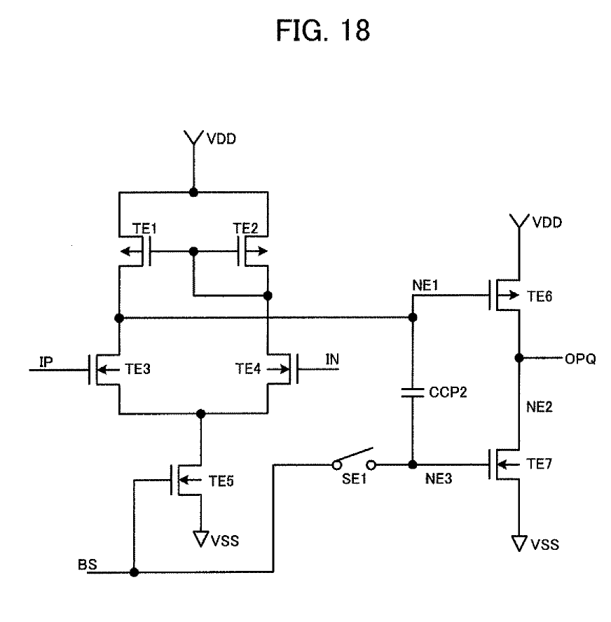

FIG. 18 shows a configuration example of the operational amplifier OP2 that can perform a class AB amplification operation. The operational amplifier OP2 includes a differential section (differential stage) formed by transistors TE1, TE2, TE3, TE4, and TE5, and an output section (output stage) formed by transistors TE6 and TE7.

The operational amplifier OP2 shown in FIG. 18 differs from the operational amplifier OP1 shown in FIG. 14 in that a switch element SE1 is provided. A bias voltage BS is supplied to one end of the switch element SE1, and the other end of the switch element SE1 is connected to a gate node NE3 of the transistor TE7 of the output section. A capacitor CCP2 is provided between an output node NE1 of the differential section and the gate node NE3 of the transistor TE7.

The switch element SE1 is turned ON in the driver amplifier sampling period. Therefore, the bias voltage BS is input to the gate of the transistor TE7 of the output section so that the operational amplifier OP2 shown in FIG. 18 functions as an amplifier that performs a class A amplification operation. The switch element SE1 is turned OFF in the driver amplifier holding period. Therefore, the gate node NE3 of the transistor TE7 is set in a floating state so that the voltage of a node NE2 changes corresponding to a change in the voltage of the node NE1 due to the capacitor CCP2. As a result the operational amplifier OP2 shown in FIG. 18 functions as an amplifier that performs a class AB amplification operation.

7. Number of Switch Elements

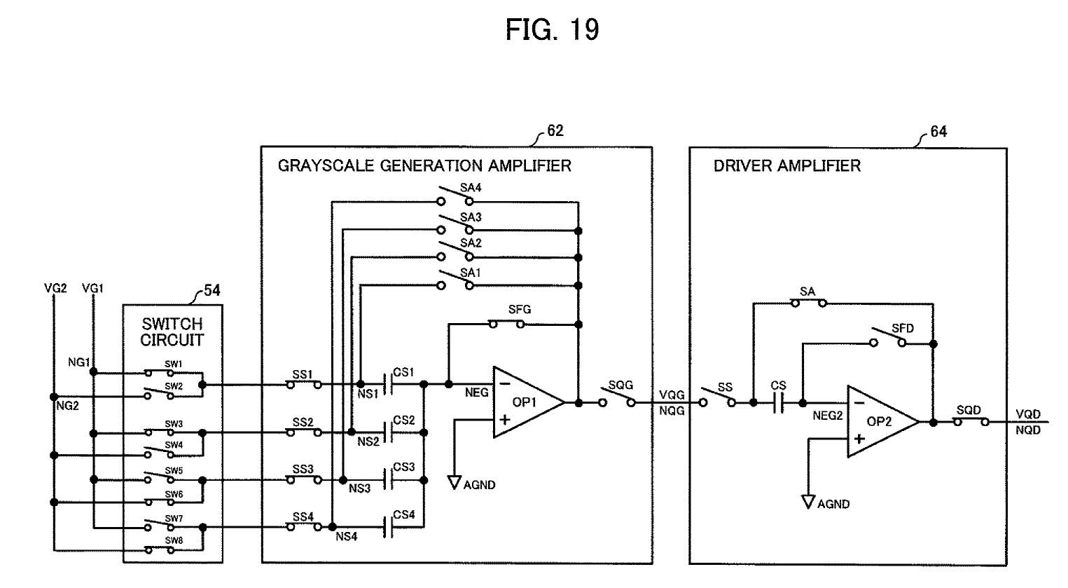

FIG. 19 shows a third modification of the data driver. In FIG. 16, the four switch elements SW1 to SW4 are provided in the switch circuit 54. Note that this embodiment is not limited thereto. For example, eight switch elements SW1 to SW8 are provided in the switch circuit 54 shown in FIG. 19. Note that the number of switch elements may be larger than eight (e.g., sixteen or thirty-two).

In FIG. 16, the grayscale generation amplifier 62 includes the two sampling switch elements SS1 and SS2, the two sampling capacitors CS1 and CS2, and the two flip-around switch elements SA1 and SA. Note that the numbers of these elements are not limited two. In FIG. 19, the grayscale generation amplifier 62 includes four sampling switch elements SS1 to SS4, four sampling capacitors CS1 to CS4, and four flip-around switch elements SA1 to SA4, for example. Note that the numbers of these elements may be larger than four (e.g., eight or sixteen).

In FIG. 19, the switch elements SW1 and SW2, the switch elements SW3 and SW4, the switch elements SW5 and SW6, and the switch elements SW7 and SW8 are exclusively turned ON/OFF, respectively. The grayscale generation amplifier 62 is caused to generate a grayscale voltage between the first grayscale voltage VG1 and the second grayscale voltage VG2 in the same manner as in FIG. 7 by causing the switch elements SW1 to SW8 to be turned ON/OFF. In FIG. 7, one grayscale voltage between the first grayscale voltage VG1 and the second grayscale voltage VG2 is generated. In FIG. 19, three grayscale voltages between the first grayscale voltage VG1 and the second grayscale voltage VG2 can be generated.

For example, when the number of bits of grayscale data is eight (i.e., the number of grayscales is 2⁸ (=256)), it suffices that the grayscale voltage generation circuit 110 generate 128 grayscale voltages when using the configuration shown in FIG. 16. Therefore, it suffices that the D/A conversion circuit 52 include selectors that select voltages from the 128 grayscale voltages.

According to the configuration shown in FIG. 19, it suffices that the grayscale voltage generation circuit 110 generate 64 grayscale voltages. Therefore, it suffices that the D/A conversion circuit 52 include selectors that select voltages from the 64 grayscale voltages. Accordingly, the circuit scale of the grayscale voltage generation circuit 110 and the D/A conversion circuit 52 and the number of grayscale voltage lines can be further reduced so that the area of the integrated circuit device including the data driver can be further reduced.

8. Configuration Example of D/A Conversion Circuit

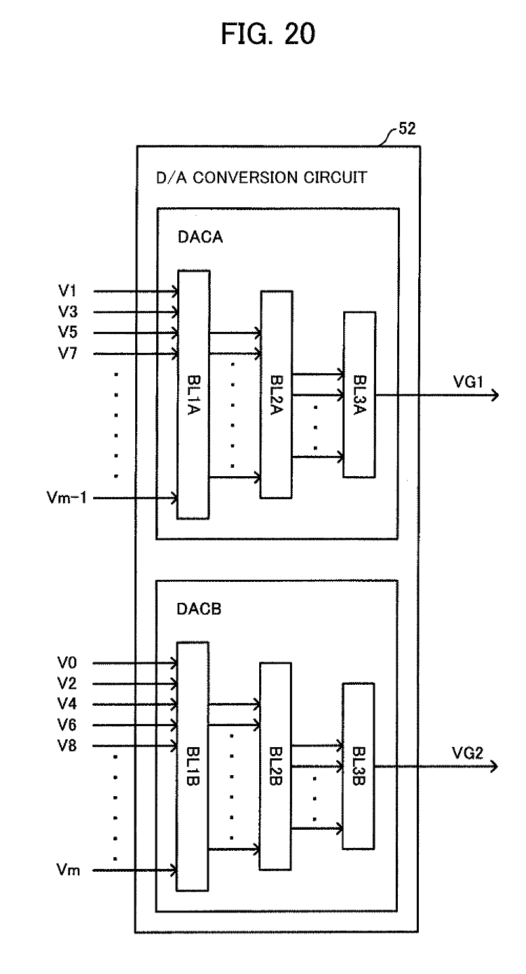

FIG. 20 shows a configuration example of the D/A conversion circuit 52. The D/A conversion circuit 52 includes a first D/A converter DACA and a second D/A converter DACB.

The first D/A converter DACA (odd-number DAC) selects a grayscale voltage (voltage in a broad sense) corresponding to the grayscale data (input data in a broad sense) from a plurality of grayscale voltages V1, V3, VS, V7, . . . , and Vm-1 (a plurality of input voltages in a broad sense), and outputs the selected voltage as the first grayseale voltage VG1 (first voltage in a broad sense).

The second D/A converter DACB (even-number DAC) selects a grayscale voltage (voltage) corresponding to the grayscale data (input data) from a plurality of grayscale voltages V0, V2, V4, V6, V8, . . . , and Vm (a plurality of input voltages), and outputs the selected voltage as the second grayscale voltage VG2 (second voltage in a broad sense). The first grayscale voltage VG1 and the second grayscale voltage VG2 are voltages that differ by at least 1LSB of the grayscale data (input data), for example.

The first D/A converter DACA includes multi-stage selector blocks BL1A, BL2A, and BL3A, the output from a selector included in the selector block in the preceding stage being input to a selector included in the selector block in the subsequent stage. The second D/A converter DACB includes multi-stage selector blocks BL1B, BL2B, and BL3B, the output from a selector included in the selector block in the preceding stage being input to a selector included in the selector block in the subsequent stage. The number of stages of the selector blocks is not limited to three employed in FIG. 20, but may be two, or four or more.

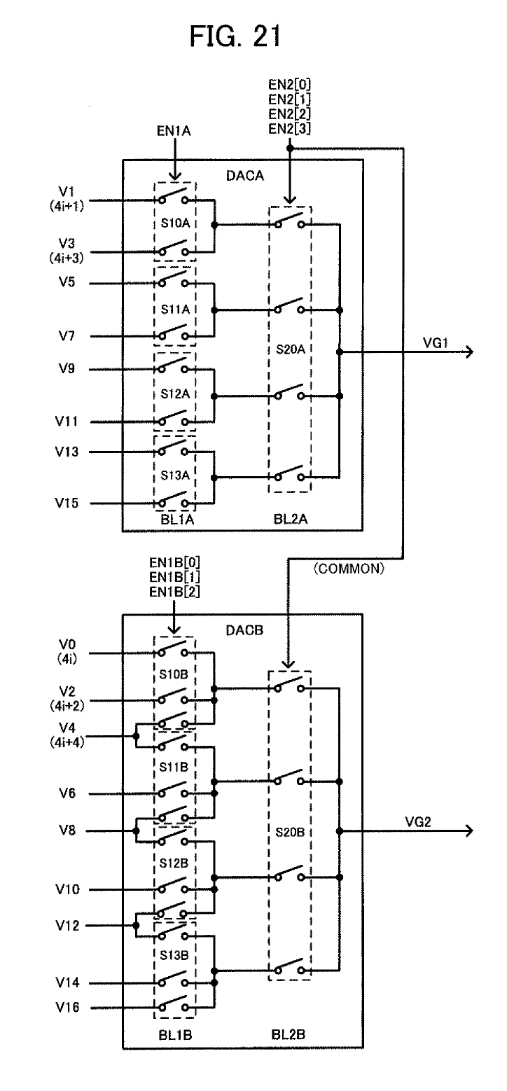

FIG. 21 shows a detailed configuration example of the first D/A converter DACA and the second D/A converter DACB. Each of the first D/A converter DACA and the second D/A converter DACB selects one grayscale voltage from a plurality of grayscale voltages by a tournament method, and outputs the selected voltage as the first grayscale voltage VG1 or the second grayscale voltage VG2.

As shown in FIG. 21, the first-stage selector block BL1A of the first D/A converter DACA includes a plurality of two-input selectors S10A to S13A (2-to-1 selectors). The first-stage selector block BL1B of the second D/A converter DACB includes a plurality of three-input selectors S10B to S13B (3-to-1 selectors). A switch element included in the selector may be formed by a transfer gate including a P-type transistor and an N-type transistor, for example.

The two-input selector S10A (ith two-input selector, i=0) among the plurality of two-input selectors of the first D/A converter DACA selects the grayscale voltage V1 ((4i+1)th input voltage) or the grayscale voltage V3 ((4i+3)th input voltage) based on the grayscale data (input data), and outputs the selected grayscale voltage to a four-input selector S20A of the selector block BL2A in the subsequent stage.

The two-input selector S11A (ith two-input selector, i=1) selects the grayscale voltage V5 ((4i+1)th input voltage) or the grayscale voltage V7 ((4i+3)th input voltage) based on the grayscale data, and outputs the selected grayscale voltage to the four-input selector S20A in the subsequent stage. This also applies to the two-input selector S12A and S13A.

The four-input selector S20A selects the output voltage from the two-input selector S10A, S11A, S12A, or S13A, and outputs the selected output voltage as the first grayscale voltage VG1.

The three-input selector S10B (ith three-input selector, i=0) among the plurality of three-input selectors of the second D/A converter DACB selects the grayscale voltage V0 (4ith input voltage), the grayscale voltage V2 ((4i+2)th input voltage), or the grayscale voltage V4 ((4i+4)th input voltage) based on the grayscale data (input data), and outputs the selected grayscale voltage to a four-input selector S20B of the selector block BL2B in the subsequent stage.

The three-input selector S11B (ith three-input selector, i=1) selects the grayscale voltage V4 (4ith input voltage), the grayscale voltage V6 ((4i+2)th input voltage), or the grayscale voltage V8 ((4i+4)th input voltage) based on the grayscale data, and outputs the selected grayscale voltage to the four-input selector S20B in the subsequent stage. This also applies to the three-input selectors S12B and S13B.

The four-input selector S20B selects the output voltage from the three-input selector S10B, S11B, S12B, or S13B, and outputs the selected output voltage as the second grayscale voltage VG2.

In the second D/A converter DACB, the grayscale voltage V4 is input to the three-input selectors S10B and S11B, as shown in FIG. 21. The grayscale voltage V8 is input to the three-input selectors S11B and S12B, and the grayscale voltage VI2 is input to the three-input selectors S12B and S13B.

The two-input selectors S10A to S13A of the first D/A converter DACA are controlled based on a selector control signal EN1A dedicated to the first D/A converter DACA.

Specifically, one of two switch elements of each of the two-input selectors S10A to S13A is turned ON and the other switch element is turned OFF based on the voltage level of the selector control signal EN1A.

The three-input selectors S10B to S13B of the second D/A converter DACB are controlled based on selector control signals EN1B[2] to EN1B[0] dedicated to the second D/A converter DACB.

Specifically, one of three switch elements of each of the three-input selectors S10B to S13B is turned ON and the remaining switch elements are turned OFF based on the voltage levels of the selector control signals EN1B[2] to EN1B[0].

The four-input selector S20A included in the second-stage (second or subsequent-stage) selector block BL2A of the first D/A converter DACA and the four-input selector S20B included in the second-stage (second or subsequent-stage) selector block BL2B of the second D/A converter DACB are controlled based on selector control signals EN2[3] to EN2[0].

Specifically, one of four switch elements of the four-input selector S20A is turned ON and the remaining switch elements are turned OFF based on the voltage levels of the selector control signals EN2[3] to EN2[0]. The first grayscale voltage VG1 is thus output from the first D/A converter DACA.

One of four switch elements of the four-input selector S20B is turned ON and the remaining switch elements are turned OFF based on the voltage levels of the selector control signals EN2[3] to EN2[0]. The second grayscale voltage VG2 is thus output from the second D/A converter DACB.

According to the configuration shown in FIG. 21, the numbers of switch elements of the selectors of the first D/A converter DACA and the second D/A converter DACB can be reduced while reducing the number of selector control signals.

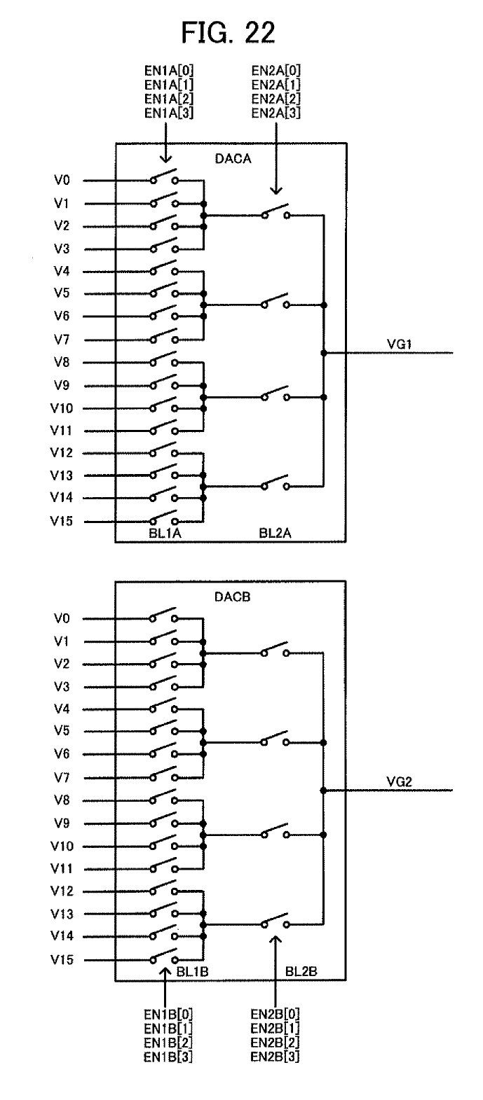

FIG. 22 shows a second configuration example of the first D/A converter DACA and the second D/A converter DACB. In FIG. 22, the first D/A converter DACA is configured so that one grayscale voltage can be selected from sixteen grayscale voltages V0 to V15. The second D/A converter DACB is also configured so that one grayscale voltage can be selected from sixteen grayscale voltages V0 to V15.

A four-input selector included in the first-stage selector block BL1A of the first D/A converter DACA is controlled based on selector control signals EN1A[3] to EN1A[0], and a four-input selector included in the second-stage selector block BL2A is controlled based on selector control signals EN2A[3] to EN2A[0].

Likewise, a four-input selector included in the first-stage selector block BL1B of the second D/A converter DACB is controlled based on selector control signals EN1B[3] to EN1B[0], and a four-input selector included in the second-stage selector block BL2B is controlled based on selector control signals EN2B[3] to EN2B[0].

According to the first configuration example shown in FIG. 21, the number of switch elements can be reduced from 40 to 28 as compared with the second configuration example shown in FIG. 22. Moreover, the number of selector control signals can be reduced from sixteen to eight. Therefore, the circuit area of the D/A conversion circuit 52 can be reduced as compared with FIG. 22. Moreover, since the number of selector control signals is reduced, the signal line wiring area can be reduced so that the area of the integrated circuit device can be reduced.

9. Adjustment of Minimum Grayscale Voltage and Maximum Grayscale Voltage

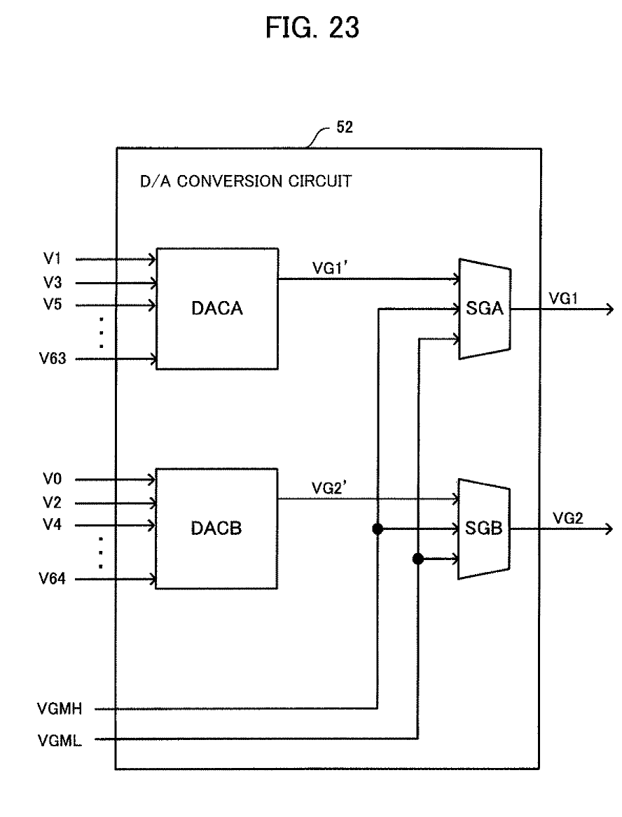

FIG. 23 shows a modification of the D/A conversion circuit 52. In FIG. 23, a minimum grayscale voltage VGML (e.g., a minimum grayscale voltage with respect to 0 V) and a maximum grayscale voltage VGMH (e.g., a maximum grayscale voltage with respect to 0 V) can be adjusted.

Specifically, the first D/A converter DACA shown in FIG. 23 receives the grayscale voltages V1, V3, V5, . . . , and V63, selects the voltage corresponding to the grayscale data, and outputs the selected voltage as a grayscale voltage VG1′. The second D/A converter DACB receives the grayscale voltages V0, V2, V4, . . . , and V64, selects the voltage corresponding to the grayscale data, and outputs the selected voltage as a grayscale voltage VG2′. The first D/A converter DACA and the second D/A converter DACB may have the configuration (i.e., 64-grayscale configuration) described with reference to FIG. 21, for example. Note that the configuration described with reference to FIG. 22 may also be employed.

A three-input selector SGA selects the grayscale voltage VG1′ from the first D/A converter DACA, the maximum grayscale voltage VGMH, or the minimum grayscale voltage VGML, and outputs the selected grayscale voltage as the first grayscale voltage VG1. A three-input selector SGB selects the grayscale voltage VG2′ from the second D/A converter DACB, the maximum grayscale voltage VGMH, or the minimum grayscale voltage VGML, and outputs the selected grayscale voltage as the first grayseale voltage VG2.

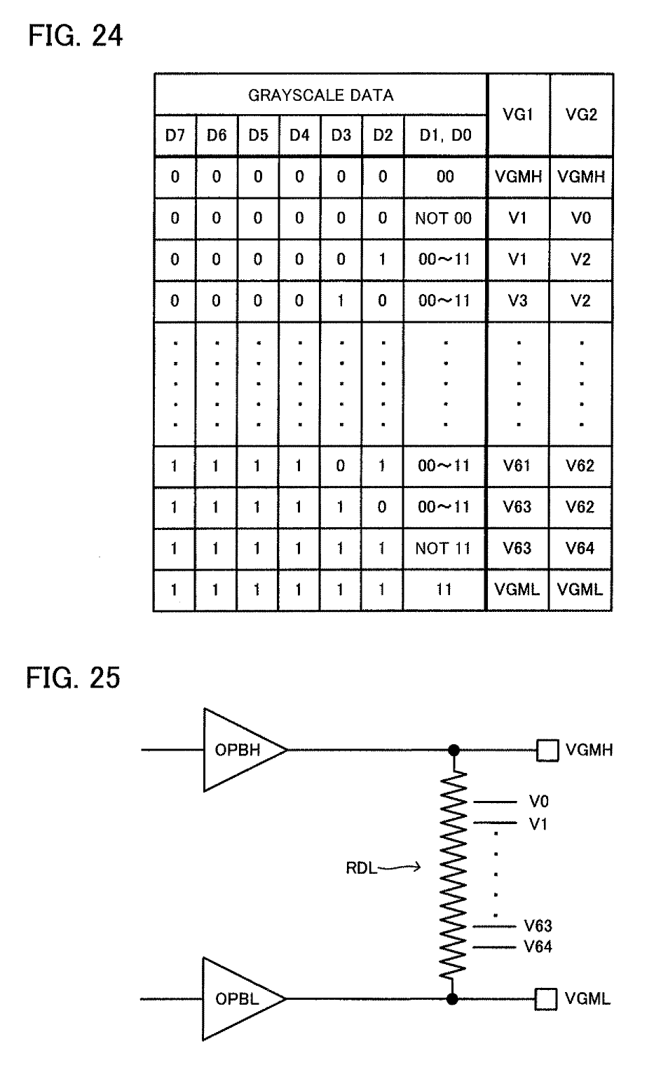

As shown in FIG. 24, when all of the bits D7 to D0 of the grayscale data DG are set at “0” (first logic level in a broad sense) (i.e., DG=(00000000)), the D/A conversion circuit 52 outputs the maximum grayscale voltage VGMH as the first grayscale voltage VG1, and outputs the maximum grayscale voltage VGMH as the second grayscale voltage VG2. Specifically, the three-input selectors SGA and SGB shown in FIG. 23 select and output the maximum grayscale voltage VGMH.

On the other hand, when all of the bits D7 to D0 of the grayscale data DG are set at “1” (second logic level in a broad sense) (i.e., DG=(11111111)), the D/A conversion circuit 52 outputs the minimum grayscale voltage VGML as the first grayscale voltage VG1, and outputs the minimum grayscale voltage VGML as the second grayscale voltage VG2. Specifically, the three-input selectors SGA and SGB shown in FIG. 23 select and output the minimum grayscale voltage VGML.

When the grayscale data DG is not (00000000) or (11111111), the three-input selectors SGA and SGB output the grayscale voltage VG1′ from the first D/A converter DACA and the grayscale voltage VG2′ from the second D/A converter DACB as the first grayscale voltage VG1 and the second grayscale voltage VG2, respectively. Specifically, the three-input selectors SGA and SGB output the grayscale voltage VG1′ output from the first D/A converter DACA and the grayscale voltage VG2′ output from the second D/A converter DACB as the first grayscale voltage VG1 and the second grayscale voltage VG2 using the method described with reference to FIG. 7 and the like.

FIG. 25 shows a configuration example of the grayscale voltage generation circuit 110 for implementing the method shown in FIGS. 23 and 24. In FIG. 25, an amplifier OPBH generates and outputs the maximum grayscale voltage VGMH, and an amplifier OPBL generates and outputs the minimum grayscale voltage VGML. The grayscale voltages V0, V1, V2, . . . , V63, and V64 are generated at tap positions of a ladder resistor circuit RDL by dividing the voltage between the maximum grayscale voltage VGMH and the minimum grayscale voltage VGML using the ladder resistor circuit RDL, and are output to the D/A conversion circuit 52.

In FIGS. 24 and 25, the grayscale voltage V0 is a high-potential-side voltage, and the grayscale voltage V64 is a low-potential-side voltage. Note that the grayscale voltage V0 may be a low-potential-side voltage, and the grayscale voltage V64 may be a high-potential-side voltage.

It is desirable that the amplifiers OPBH and OPBL variably set the maximum grayscale voltage VGMH and the minimum grayscale voltage VGML. Specifically, the voltage value is variably set by a command-based register setting. The grayscale voltage generation circuit 110 may further include an operational amplifier that subjects the voltage divided by the ladder resistor circuit RDL to impedance conversion, for example.

In this embodiment, the grayscale generation amplifier 62 generates the grayscale voltage between the grayscale voltages V0 and V1, the grayscale voltage between the grayscale voltages V1 and V2, the grayscale voltage between the grayscale voltages V2 and V3, and the like as described with reference to FIG. 7, for example. In this case, the intervals between the grayscale voltages are equal, as shown in FIG. 7.

On the other hand, it may be desirable that the interval between the maximum grayscale voltage VGMH and the grayscale voltage V0 and the interval between the minimum grayscale voltage VGML and the grayscale voltage V64 shown in FIG. 25 not be equal to the intervals between the remaining grayscale voltages. For example, when adjusting the contrast independently of gamma correction, it is desirable that the maximum grayscale voltage VGMH and the minimum grayscale voltage VGML be controlled individually.

In FIGS. 24 and 25, the D/A conversion circuit 52 outputs the maximum grayscale voltage VGMH as the first grayscale voltage VG1 and the second grayscale voltage VG2 (VG1=VG2=VGMH) when the grayscale data DG is (00000000), and outputs the minimum grayscale voltage VGML as the first grayscale voltage VG1 and the second grayscale voltage VG2 (VG1=VG2=VGML) when the grayscale data DG is (11111111), for example. Therefore, the difference between the maximum grayscale voltage VGMH and the grayscale voltage V0 and the difference between the minimum grayscale voltage VGML and the grayscale voltage V64 can be set arbitrarily (i.e., the grayscale interval can be caused to differ). Accordingly, the contrast or the like can be adjusted by setting the maximum grayscale voltage VGMH and the minimum grayscale voltage VGML independently of an adjustment of a gamma grayscale curve by setting the grayscale voltages V0 to V64. As a result, convenience can be improved.

10. Electronic Instrument

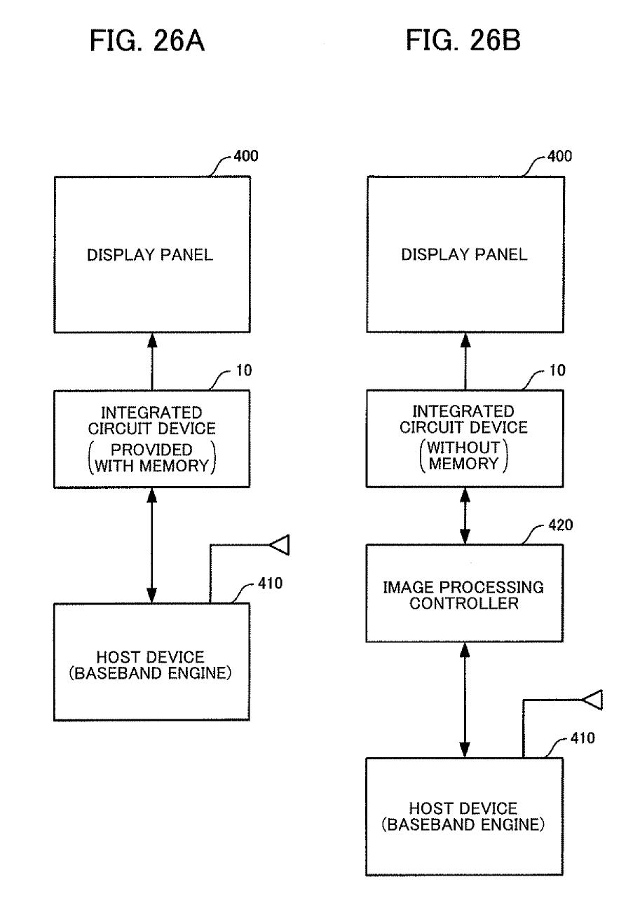

FIGS. 26A and 26B show configuration examples of an electronic instrument (electro-optical device) including the integrated circuit device 10 according to the above embodiment. Note that various modifications may be made such as omitting some of the elements shown in FIGS. 26A and 26B or adding other elements (e.g., camera, operation section, or power supply). The electronic instrument according to this embodiment is not limited to a portable telephone, but may be a digital camera, a PDA, an electronic notebook, an electronic dictionary, a projector, a rear-projection television, a portable information terminal, or the like.

In FIGS. 26A and 26B, a host device 410 is an MPU, a baseband engine, or the like. The host device 410 controls the integrated circuit device 10 (i.e., display driver). The host device 410 may also perform a process of an application engine or a baseband engine, or a process (e.g., compression, decompression, or sizing) of a graphic engine. An image processing controller 420 shown in FIG. 26B performs a process (e.g., compression, decompression, or sizing) of a graphic engine instead of the host device 410.

In FIG. 26A, the integrated circuit device 10 may include a memory. In this case, the integrated circuit device 10 writes image data from the host device 410 into the built-in memory, reads the image data from the built-in memory, and drives the display panel. In FIG. 26B, the integrated circuit device 10 may not include a memory. In this case, image data output from the host device 410 is written into a built-in memory of the image processing controller 420. The integrated circuit device 10 drives the display panel 400 under control of the image processing controller 420.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., display panel, inverting input terminal, non-inverting input terminal, AGND, VSS, and VDD) cited with a different term (e.g., electro-optical device, first input terminal, second input terminal, reference voltage, first power supply, and second power supply) having a broader meaning or the same meaning at least once in the specification and the drawings can be replaced by the different term in any place in the specification and the drawings. The configurations and the operations of the data driver, the D/A conversion circuit, the switch circuit, the data line driver circuit, the grayscale generation amplifier, the driver amplifier, the integrated circuit device, the electronic instrument, and the like are not limited to those described with reference to the above embodiments. Various modifications and variations may be made.

What is claimed is:

1. A data driver that drives a data line of an electro-optical device, the data driver comprising:
a D/A conversion circuit that receives grayscale data, and outputs a first grayscale voltage and a second grayscale voltage corresponding to the grayscale data by time division in each of first to Nth (N is an integer equal to or larger than two) sampling periods; and
first to Nth data line driver circuits that share the D/A conversion circuit,
each of the first to Nth data line driver circuits including a grayscale generation amplifier that samples the first grayscale voltage and the second grayscale voltage output from the D/A conversion circuit in a corresponding sampling period among the first to Nth sampling periods, and generates a grayscale voltage between the first grayscale voltage and the second grayscale voltage.

2. The data driver as defined in claim 1,
the grayscale generation amplifier being formed by a flip-around sample-hold circuit.

3. The data driver as defined in claim 2,
the grayscale generation amplifier including:
an operational amplifier;
a first sampling capacitor that is provided between a first input terminal of the operational amplifier and a first input node of the grayscale generation amplifier and stores a charge corresponding to an input voltage at the first input node in a sampling period; and
a second sampling capacitor that is provided between the first input terminal of the operational amplifier and a second input node of the grayscale generation amplifier and stores a charge corresponding to an input voltage at the second input node in the sampling period,
the grayscale generation amplifier outputting an output voltage in a holding period, the output voltage corresponding to charges stored in the first sampling capacitor and the second sampling capacitor in the sampling period.

4. The data driver as defined in claim 2,
the grayscale generation amplifier including:
an operational amplifier, a second input terminal of the operational amplifier being set at a given reference voltage;
a first sampling switch element and a first sampling capacitor, the first sampling switch element and the first sampling capacitor being provided between a first input node of the grayscale generation amplifier and a first input terminal of the operational amplifier;
a second sampling switch element and a second sampling capacitor, the second sampling switch element and the second sampling capacitor being provided between a second input node of the grayscale generation amplifier and the first input terminal of the operational amplifier;
a feedback switch element provided between an output terminal of the operational amplifier and the first input terminal of the operational amplifier;
a first flip-around switch element provided between a first connection node and the output terminal of the operational amplifier, the first connection node being situated between the first sampling switch element and the first sampling capacitor; and
a second flip-around switch element provided between a second connection node and the output terminal of the operational amplifier, the second connection node being situated between the second sampling switch element and the second sampling capacitor.

5. The data driver as defined in claim 4,
the first sampling switch element, the second sampling switch element, and the feedback switch element being turned ON and the first flip-around switch element and the second flip-around switch element being turned OFF in the sampling period; and
the first sampling switch element, the second sampling switch element, and the feedback switch element being turned OFF and the first flip-around switch element and the second flip-around switch element being turned ON in a holding period.

6. The data driver as defined in claim 5,
the grayscale generation amplifier including an output switch element provided between the output terminal of the operational amplifier and an output node of the grayscale generation amplifier;
the output switch element being turned OFF in the sampling period; and
the output switch element being turned ON in a holding period.

7. The data driver as defined in claim 5,
the first sampling switch element and the second sampling switch element being turned OFF after the feedback switch element has been turned OFF.

8. The data driver as defined in claim 4,
the reference voltage set to the second input terminal of the operational amplifier being an intermediate voltage between VDD and VSS,
switch control signals being supplied to the first sampling switch element, the second sampling switch element, the feedback switch element, the first flip-around switch element, and the second flip-around switch element,
VDD being a high-potential-side power supply voltage of the switch control signals, and VSS being a low-potential-side power supply voltage of the switch control signals.

9. The data driver as defined in claim 1,
each of the first to Nth data line driver circuits including a driver amplifier provided in the subsequent stage of the grayscale generation amplifier.

10. The data driver as defined in claim 9,
the driver amplifier being formed by a flip-around sample-hold circuit.

11. The data driver as defined in claim 10,
the driver amplifier including:
a second operational amplifier; and
a sampling capacitor that is provided between a first input terminal of the second operational amplifier and an input node of the driver amplifier and stores a charge corresponding to an input voltage at the input node in a driver amplifier sampling period,
the driver amplifier outputting an output voltage in a driver amplifier holding period, the output voltage corresponding to a charge stored in the sampling capacitor in the driver amplifier sampling period.

12. The data driver as defined in claim 10,
the driver amplifier including:
a second operational amplifier, a second input terminal of the second operational amplifier being set at a given reference voltage;
a sampling switch element and a sampling capacitor, the sampling switch element and the sampling capacitor being provided between an input node of the driver amplifier and a first input terminal of the second operational amplifier;
a second feedback switch element provided between an output terminal of the second operational amplifier and the first input terminal of the second operational amplifier; and
a flip-around switch element provided between a connection node and the output terminal of the second operational amplifier, the connection node being situated between the sampling switch element and the sampling capacitor.

13. The data driver as defined in claim 11,
the operational amplifier included in the grayscale generation amplifier being formed by an amplifier that performs a class A amplification operation; and
the second operational amplifier included in the driver amplifier being formed by an amplifier that performs a class AB amplification operation.

14. The data driver as defined in claim 9,
the driver amplifier included in each of the first to Nth data line driver circuits sampling an output voltage from the grayscale generation amplifier in a driver amplifier sampling period after the first to Nth sampling periods, and outputting the sampled output voltage in a driver amplifier holding period after the driver amplifier sampling period.

15. The data driver as defined in claim 14,
output lines of the driver amplifiers being set at a common potential in the driver amplifier sampling period.

16. The data driver as defined in claim 1,
the D/A conversion circuit outputting a maximum grayscale voltage as the first grayscale voltage and outputting the maximum grayscale voltage as the second grayscale voltage when all bits of the grayscale data are set at a first logic level, and outputting a minimum grayscale voltage as the first grayscale voltage and outputting the minimum grayscale voltage as the second grayscale voltage when all bits of the grayscale data are set at a second logic level.

17. An integrated circuit device comprising the data driver as defined in claim 1.

18. An electronic instrument comprising the integrated circuit device as defined in claim 17.
